(19) United States
(12) Patent Application Publication
(10) Pub. No.: US 2025/0028915 A1
(43) Pub. Date: Jan. 23, 2025

(54) Information Processing Method, Non-Transitory Computer-Readable Recording Medium, Radio Frequency Identifier Reader, and Information Processing System

(71) Applicant: Tokyo Electron Device America, Inc., Fremont, CA (US)

(72) Inventors: Yasuhiro Hamano, Fremont, CA (US); Ooki Saito, Yokohama (JP); Jiro Niihama, Fremont, CA (US); Hidekazu Usui, Fremont, CA (US); Shinichi Manaka, Fremont, CA (US); Kazuhiro Nishimura, Yokohama (JP)

(21) Appl. No.: 18/225,011

(22) Filed: Jul. 21, 2023

(51) Int. Cl. G06K 7/10

(52) U.S. Cl. CPC G06K 7/10366

(57) ABSTRACT

An information processing method according to one aspect, includes: each time when an RFID reader (1) reads a code of an RF tag, storing a read code of the RF tag and a date/time of reading and the work attribute in association with each other; and transmitting a stored code of each RF tag, a stored date/time, and a stored work attribute to a server computer (2), wherein the server computer (2) stores the code of each RF tag and the date/time and the work attribute in association with each other.

### BACKGROUND ART

In recent years, by reading information storage media (for example, RFID) attached to a target object (products, packaging of products, and the like), development of techniques for managing the target object has been actively promoted. For example, Patent Literature 1 (Japanese Patent Laid-Open Publication No. 2022-165134) discloses a product management system that determines product excess and insufficiency in product management by using the information storage medium while detecting damage to the information storage medium.

### DESCRIPTION

However, the invention according to Patent Literature 1 has a problem that it is impossible to store information about a radio frequency (RF) tag each time when a code of the RF tag is read by an RFID reader.

One aspect of the present invention is to provide an information processing method or the like capable of storing the information about the RF tag each time when the code of the RF tag is read by the RFID reader.

In the information processing method according to one aspect, each time when the RFID reader reads a code of the RF tag, a read RF tag code is associated with a date/time of reading and a work attribute, and stored. A stored code of each RF tag, a stored date/time, and a stored work attribute are transmitted to a server computer, and the server computer executes the process of associating and storing the code of each RF tag, the date/time, and the work attribute.

In one aspect, each time when the RFID reader reads the code of the RF tag, it is possible to store information about the RF tag.

The above and further objects and features will more fully be apparent from the following detailed description with accompanying drawings.

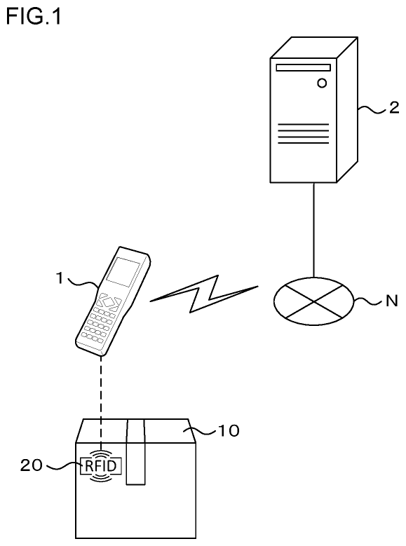

FIG. 1 is an explanatory diagram illustrating an overview of an RF tag matching system;

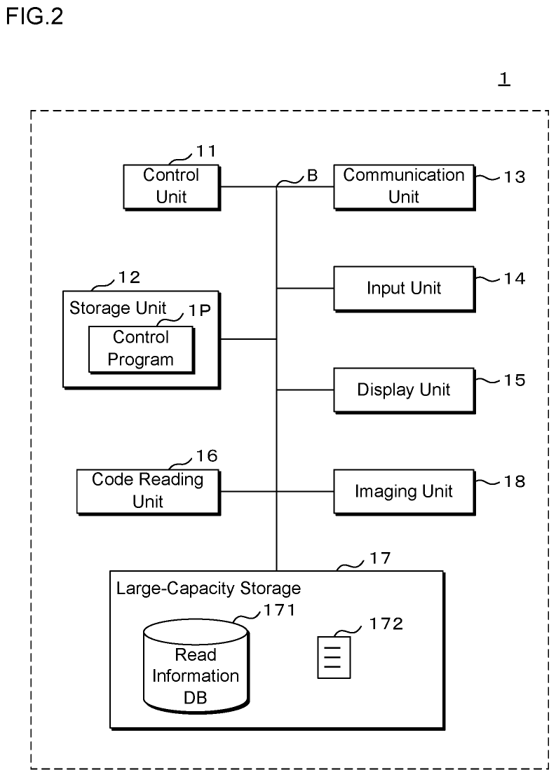

FIG. 2 is a block diagram illustrating a configuration example of an RFID reader;

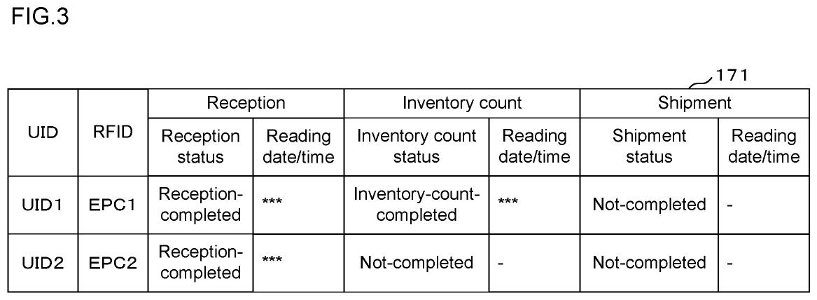

FIG. 3 is an explanatory diagram illustrating an example of a record layout of reading information DB;

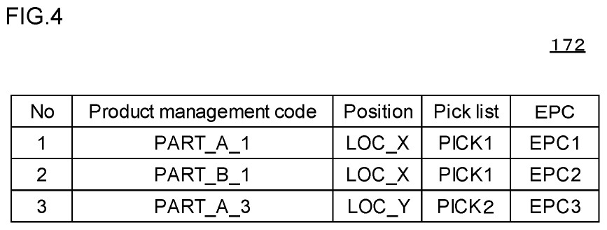

FIG. 4 is an explanatory diagram illustrating an example of a data structure of a reference file;

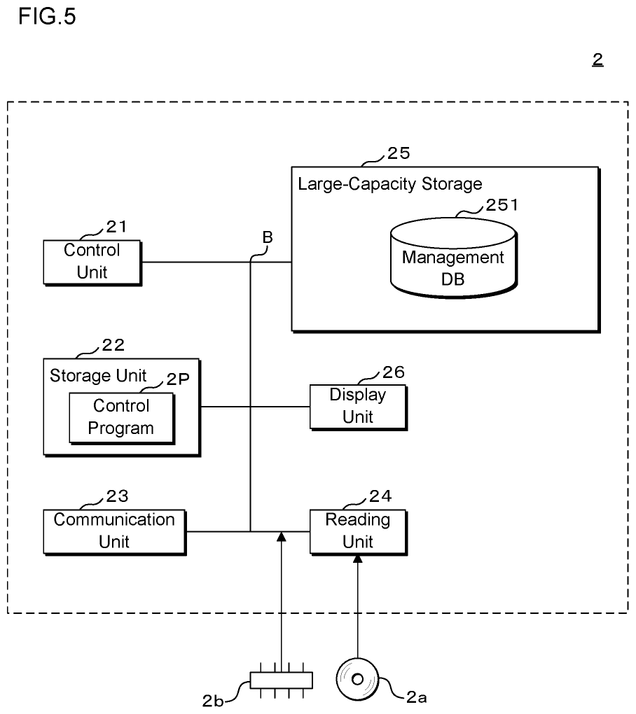

FIG. 5 is a block diagram illustrating a configuration example of a server;

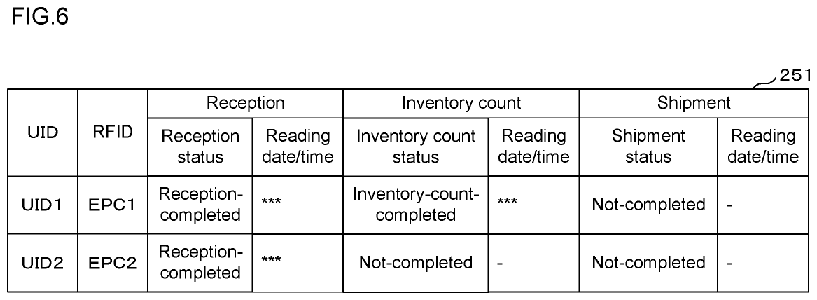

FIG. 6 is an explanatory diagram illustrating an example of a record layout of management DB;

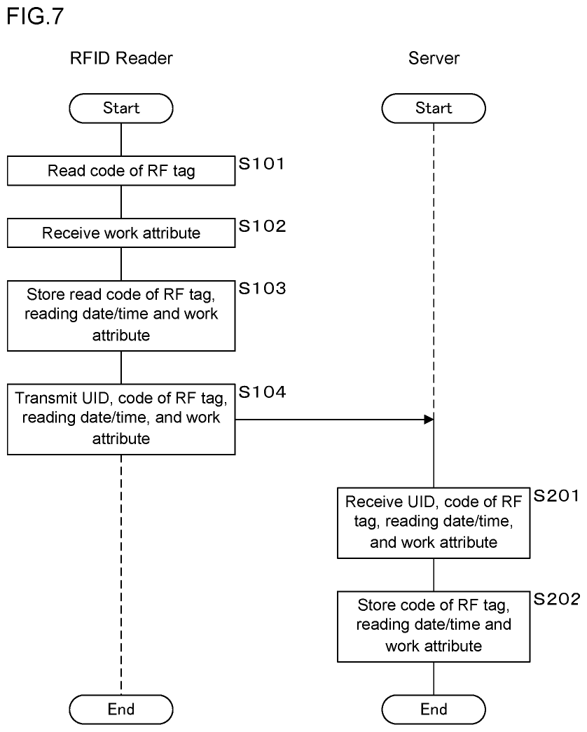

FIG. 7 is a flowchart illustrating a processing procedure for transmitting a code, reading date/time, and work attribute;

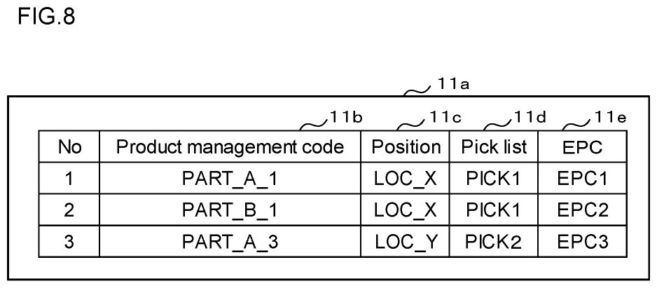

FIG. 8 is an explanatory diagram illustrating an example of a selection accepting screen of items in the reference file;

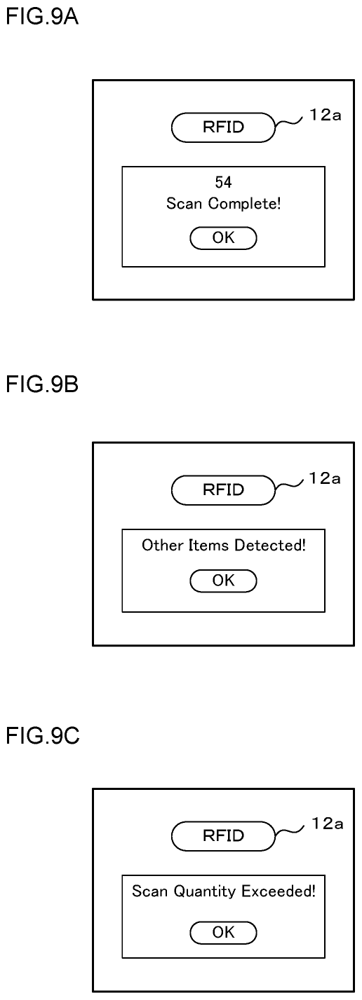

FIG. 9A is an explanatory diagram illustrating an example of a determination result of excessive and insufficient reading of an RF tag;

FIG. 9B is an explanatory diagram illustrating an example of the determination result of excessive and insufficient reading of the RF tag;

FIG. 9C is an explanatory diagram illustrating an example of the determination result of excessive and insufficient reading of the RF tag;

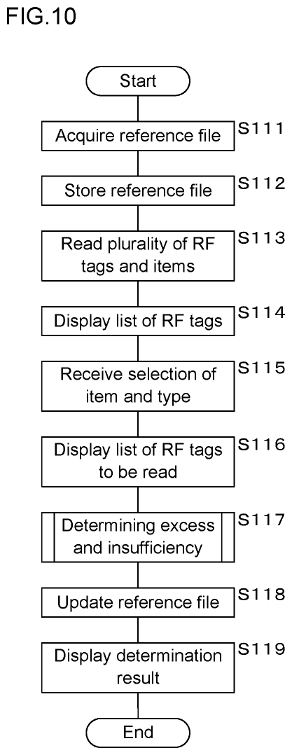

FIG. 10 is a flowchart illustrating a processing procedure for determining whether the RF tag is read excessively or insufficiently;

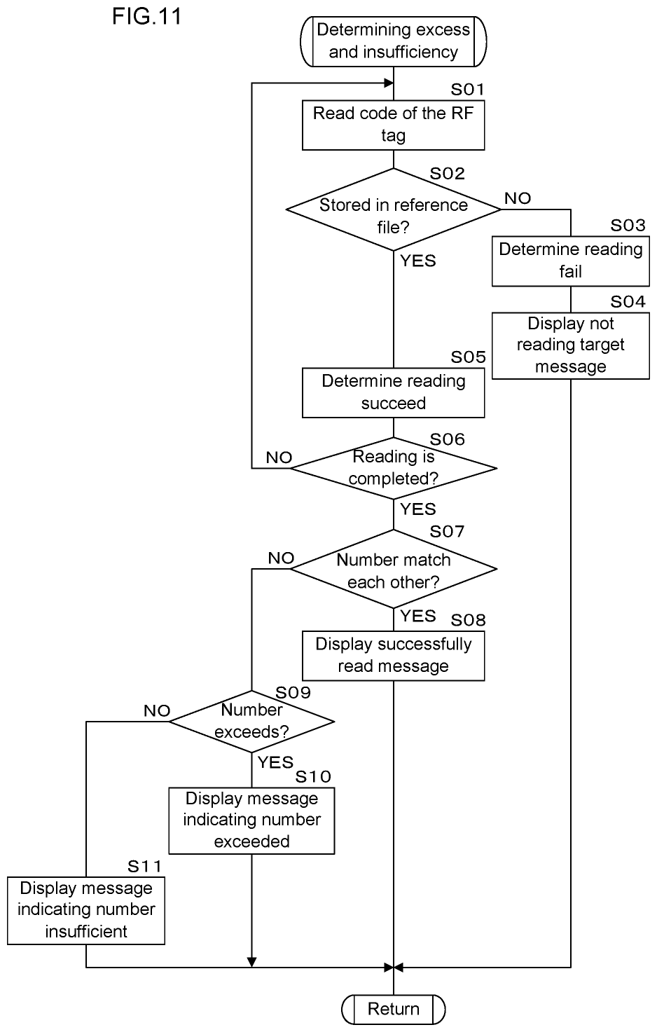

FIG. 11 is a flowchart illustrating a processing procedure of subroutine for a process determining whether the RF tag is read excessively or insufficiently;

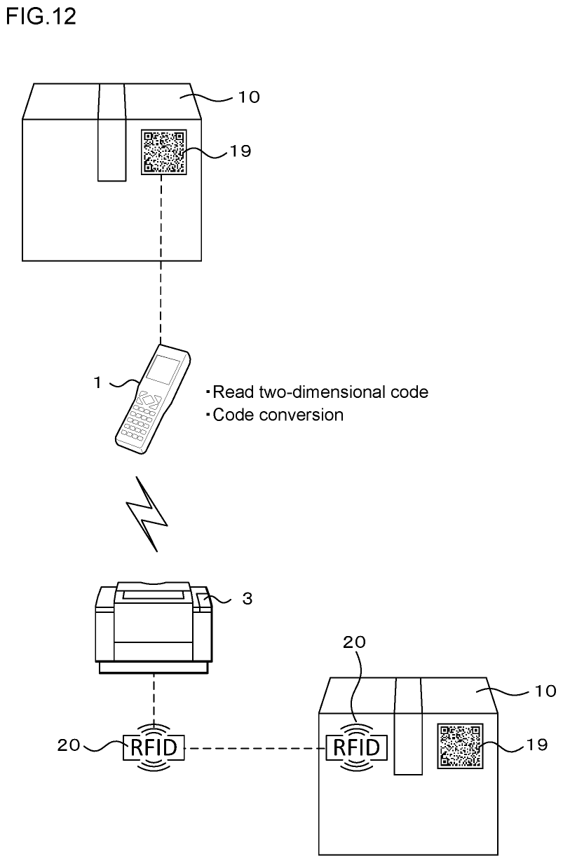

FIG. 12 is an explanatory diagram describing a code conversion process;

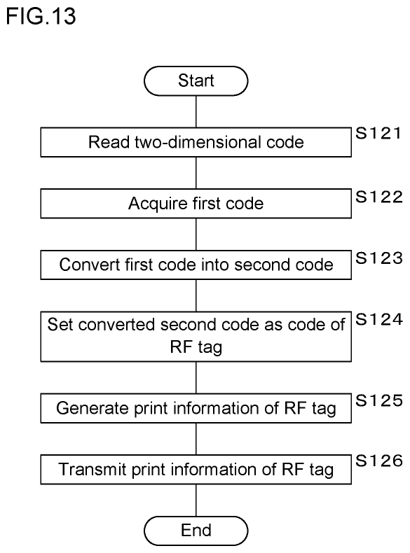

FIG. 13 is a flowchart illustrating the processing procedure when performing the code conversion process;

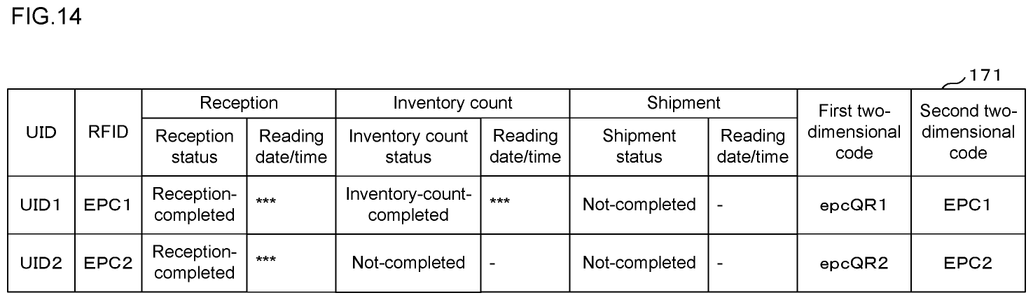

FIG. 14 is an explanatory diagram illustrating an example of record layout of read information DB according to a third embodiment;

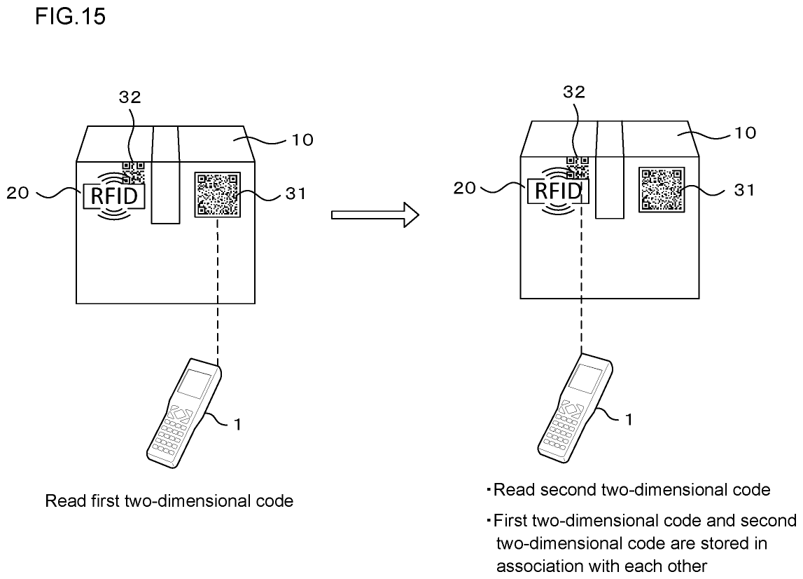

FIG. 15 is an explanatory diagram describing a process of associating and storing a code of a first two-dimensional code and a code of a second two-dimensional code;

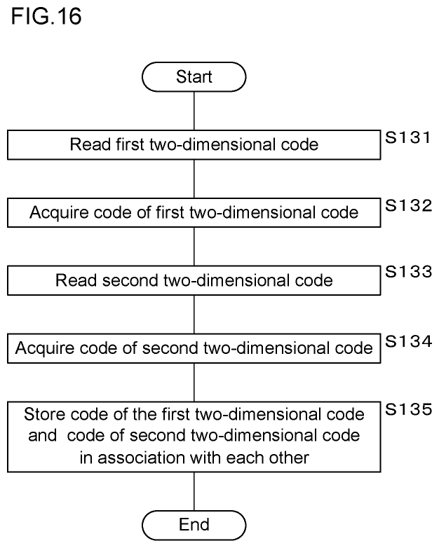

FIG. 16 is a flowchart illustrating the processing procedure when associating and storing a code of a first two-dimensional code and a code of a second two-dimensional code;

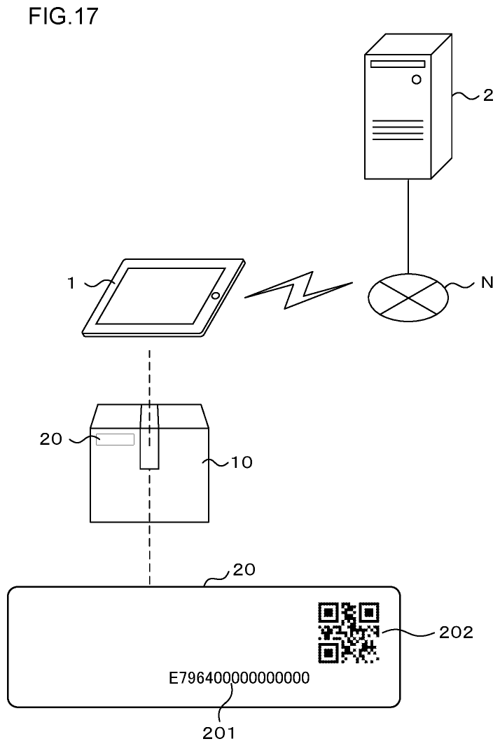

FIG. 17 is an explanatory diagram illustrating an overview of an RF tag matching system according to a fourth embodiment;

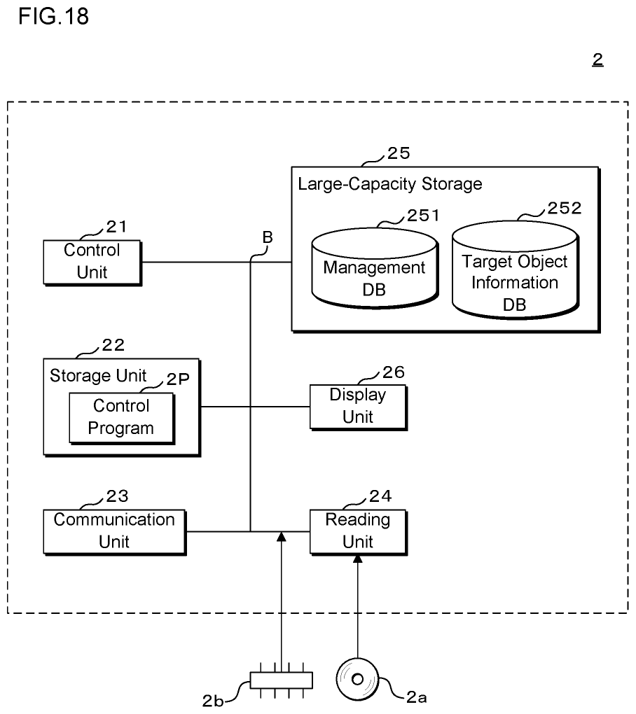

FIG. 18 is a block diagram illustrating a configuration example of a server according to the fourth embodiment;

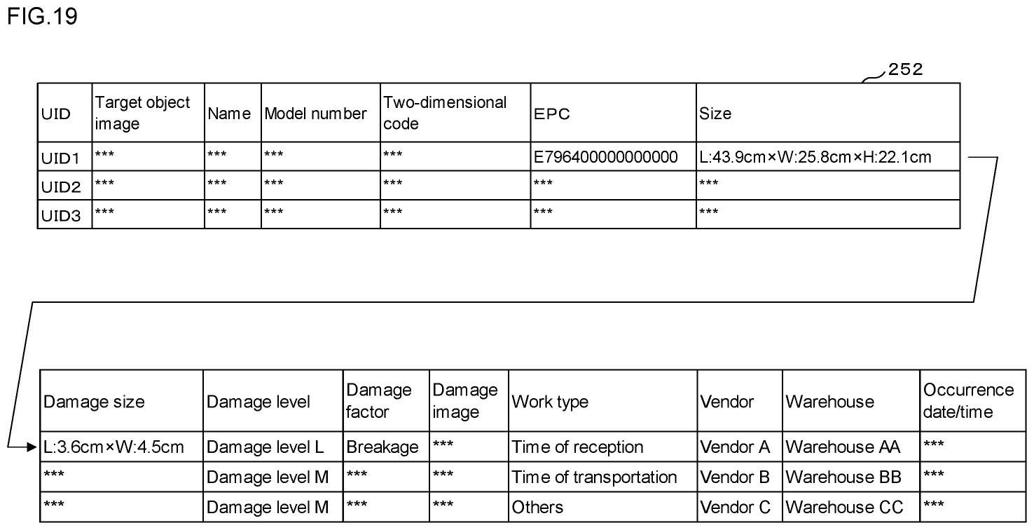

FIG. 19 is an explanatory diagram illustrating an example of a record layout of object information DB;

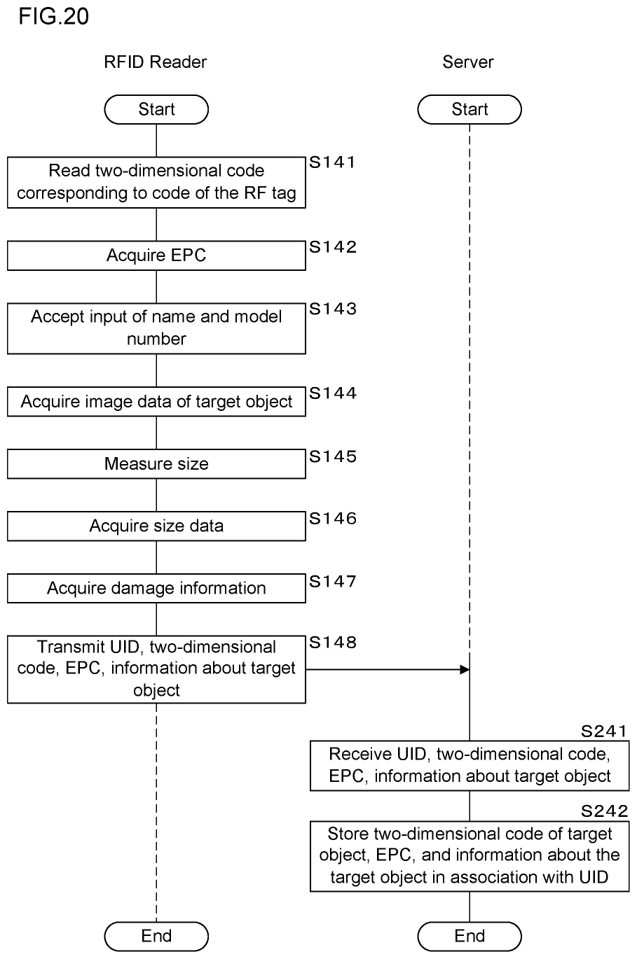

FIG. 20 is a flowchart illustrating a processing procedure when transmitting the object information to a server;

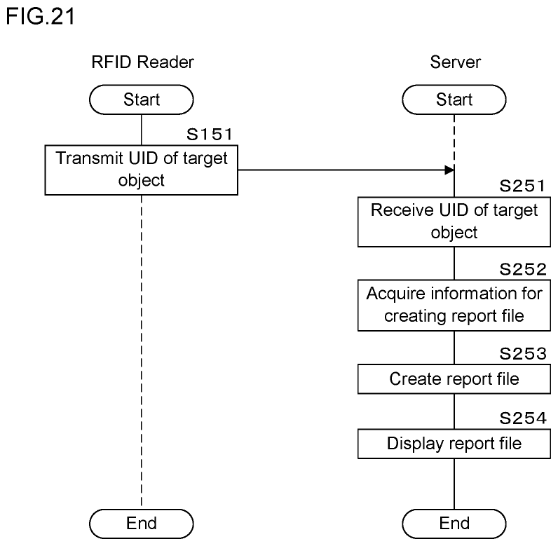

FIG. 21 is a flowchart illustrating a processing procedure when creating a report file;

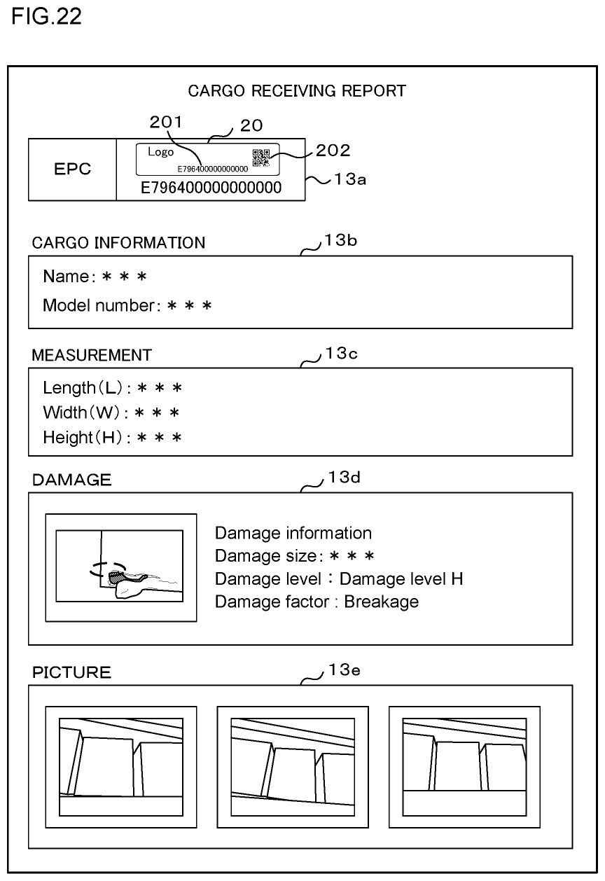

FIG. 22 is an explanatory diagram illustrating an example of the report file;

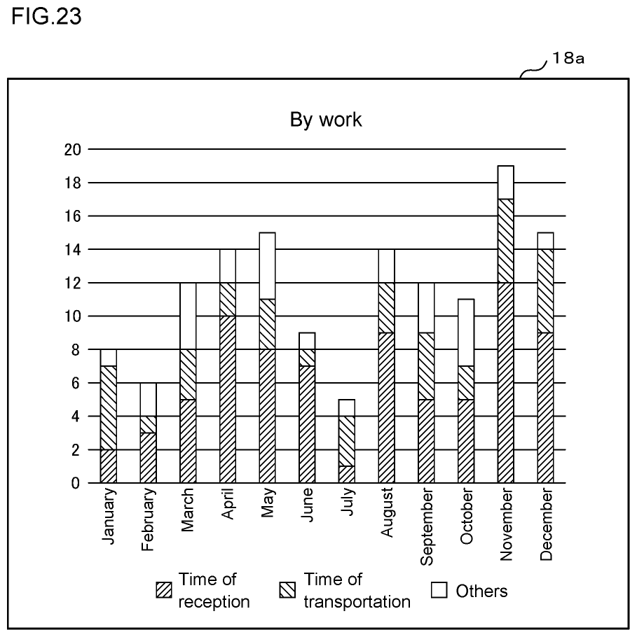

FIG. 23 is an explanatory diagram illustrating an example of a display screen of a fifth graph;

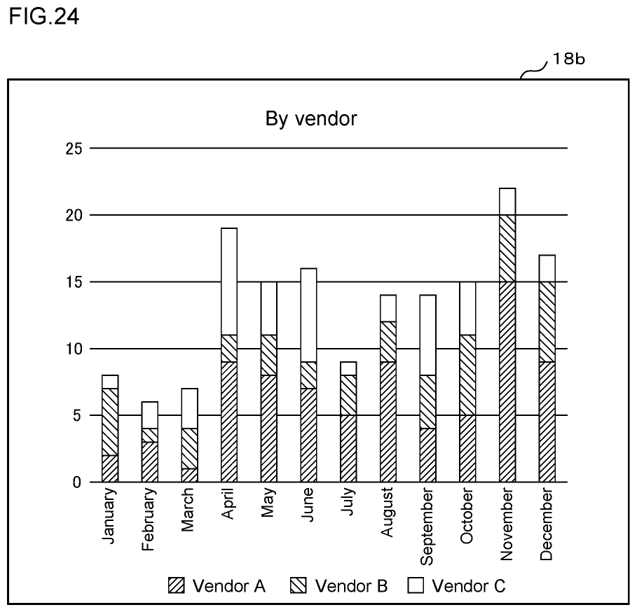

FIG. 24 is an explanatory diagram illustrating an example of a display screen of a sixth graph;

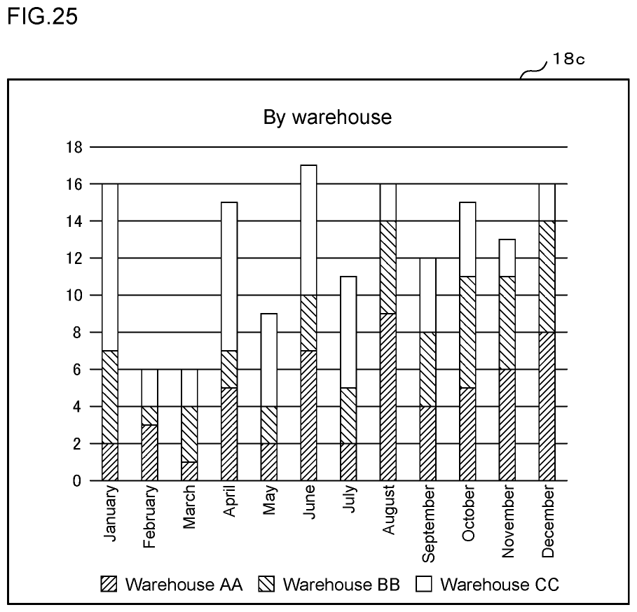

FIG. 25 is an explanatory diagram illustrating an example of a display screen of a seventh graph;

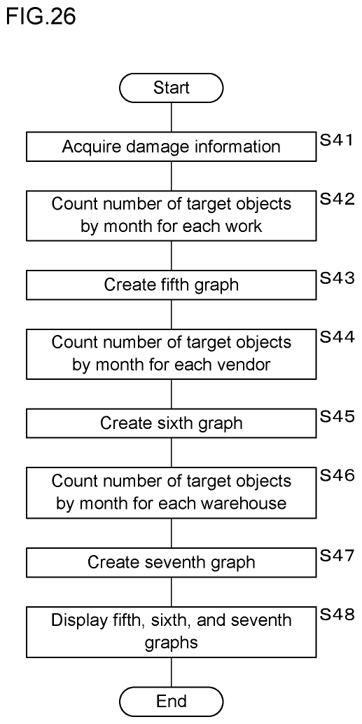

FIG. 26 is a flowchart illustrating a processing procedure when outputting a graph based on damage information of an object;

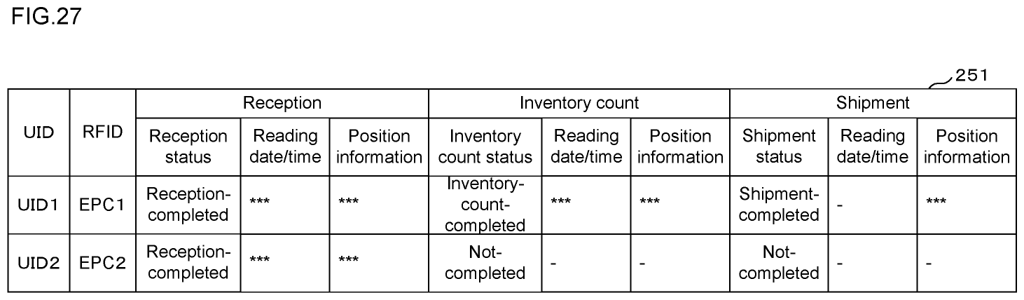

FIG. 27 is an explanatory diagram illustrating an example of a record layout of management DB according to a fifth embodiment;

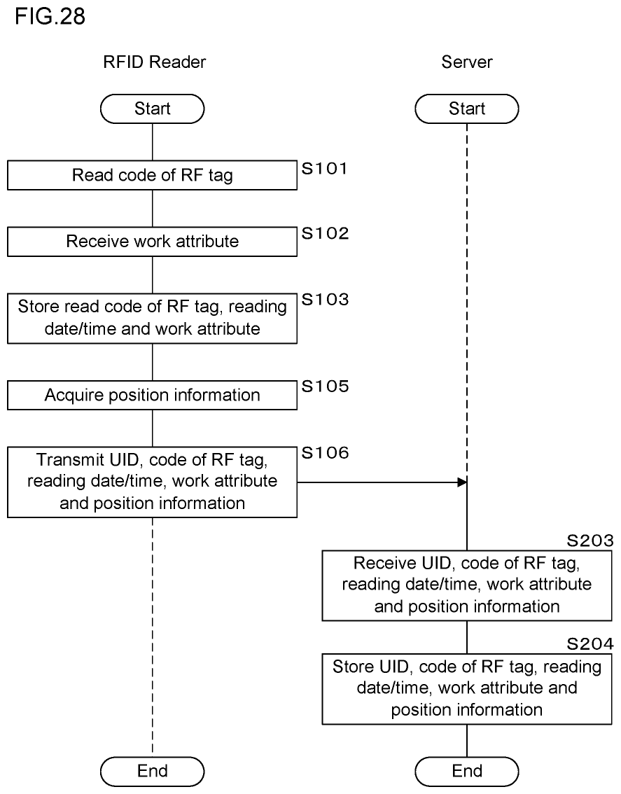

FIG. 28 is a flowchart illustrating a processing procedure when storing position information of an object;

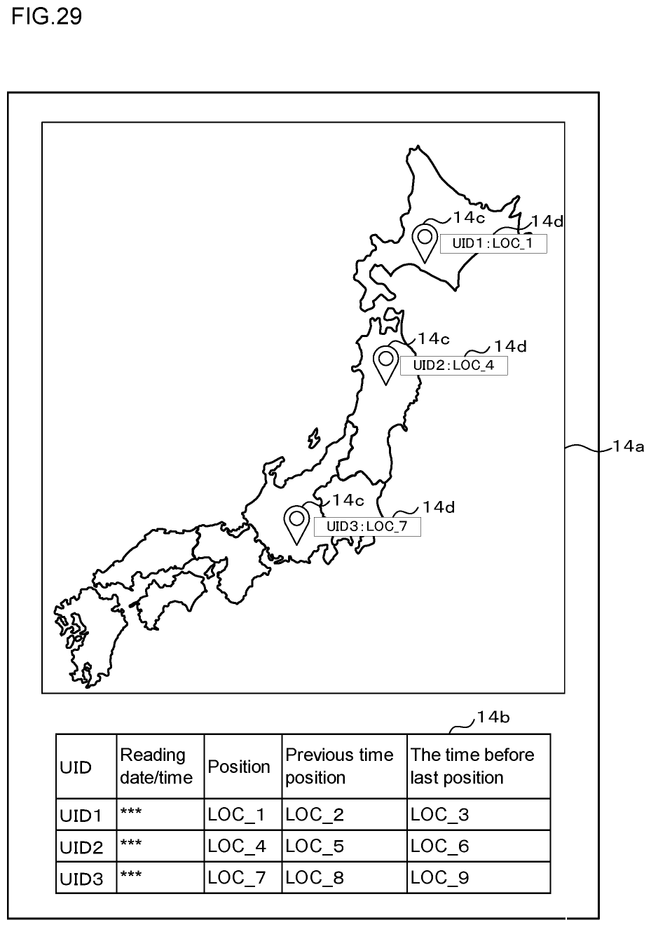

FIG. 29 is an explanatory diagram illustrating an example of a map screen illustrating a position of the object;

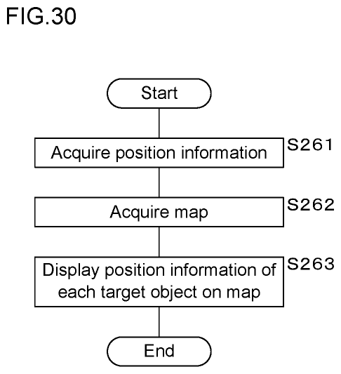

FIG. 30 is a flowchart illustrating a processing procedure when outputting a position of an object on a map;

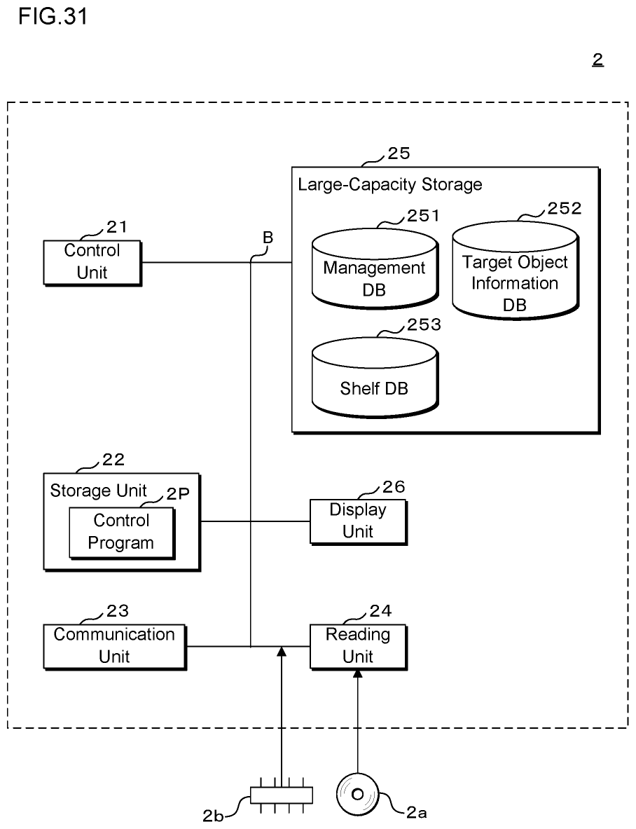

FIG. 31 is a block diagram illustrating a configuration example of a server according to a sixth embodiment;

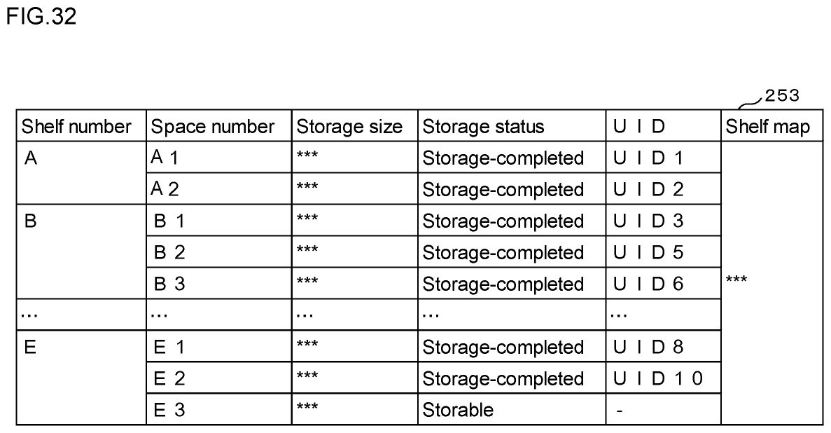

FIG. 32 is an explanatory diagram illustrating an example of a record layout of shelf DB;

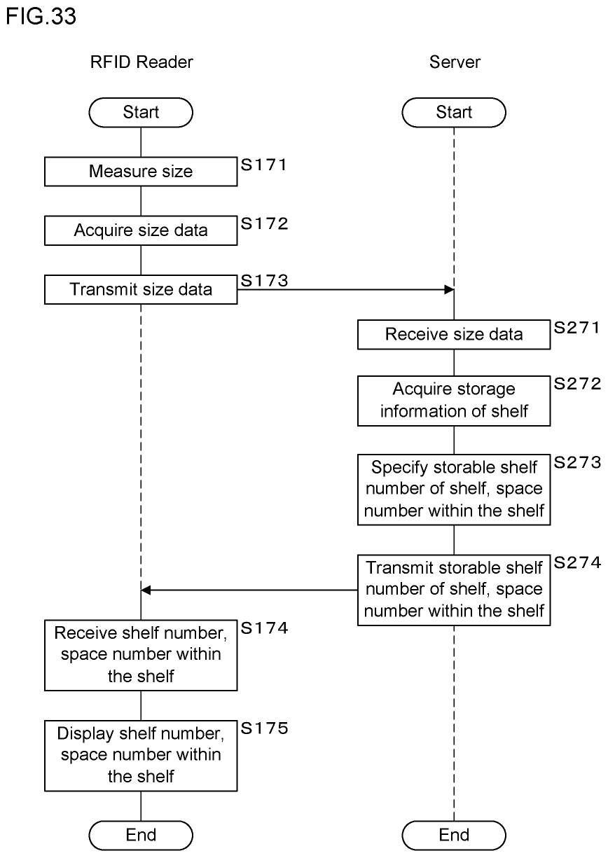

FIG. 33 is a flowchart illustrating a processing procedure when specifying a shelf capable of storing an object;

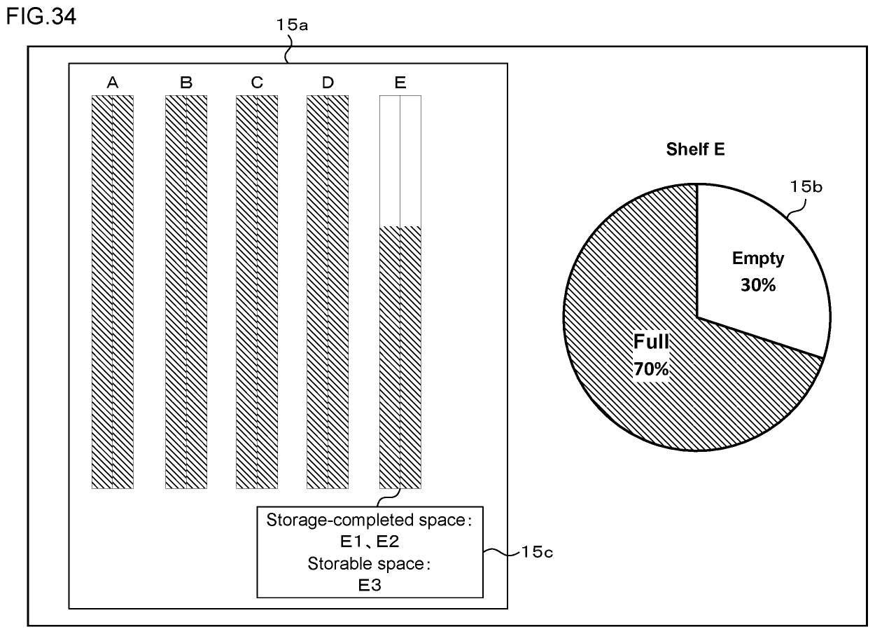

FIG. 34 is an explanatory diagram illustrating an example of a display screen for a storage status of the shelf;

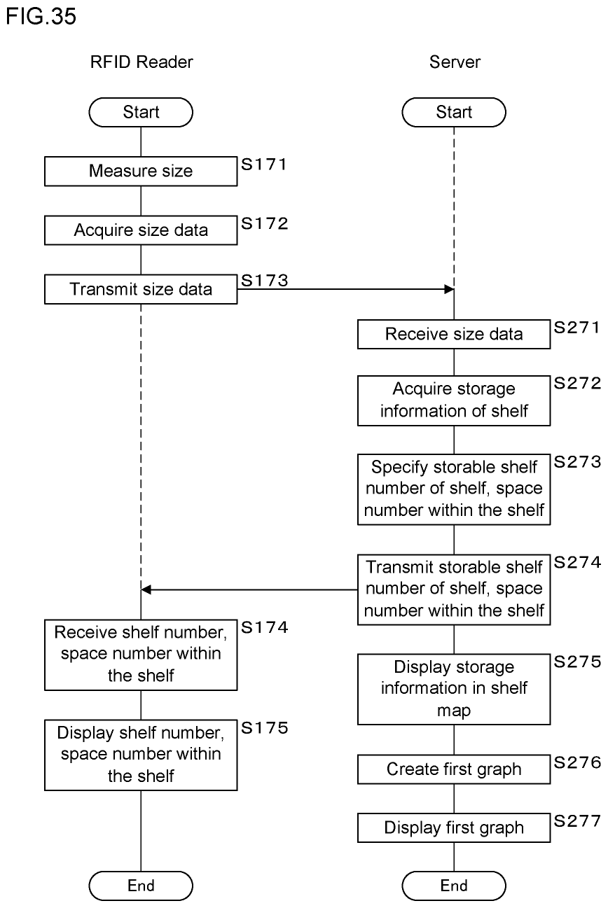

FIG. 35 is a flowchart illustrating a processing procedure for outputting a map and a first graph of the shelf;

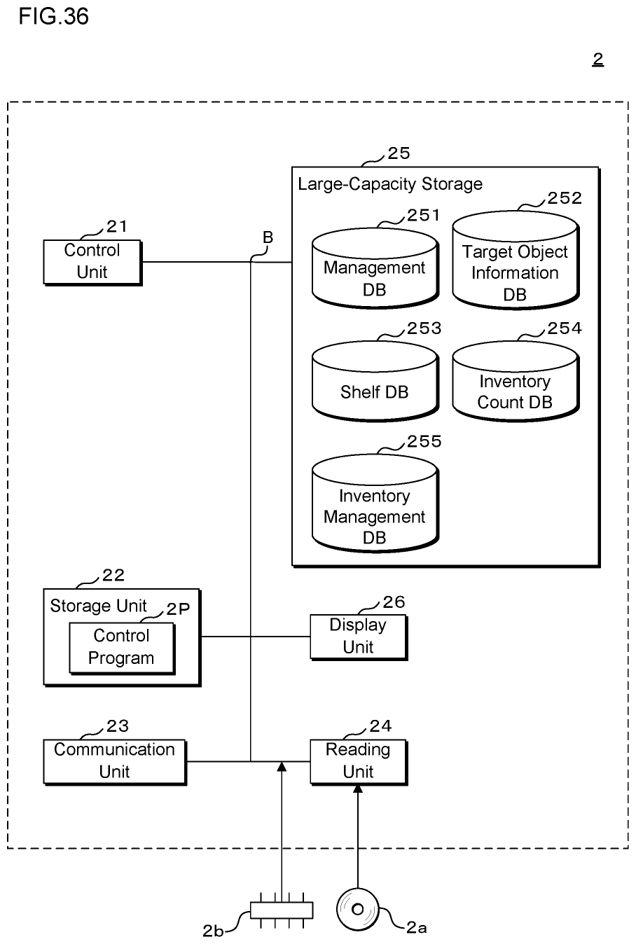

FIG. 36 is a block diagram illustrating a configuration example of a server according to a seventh embodiment;

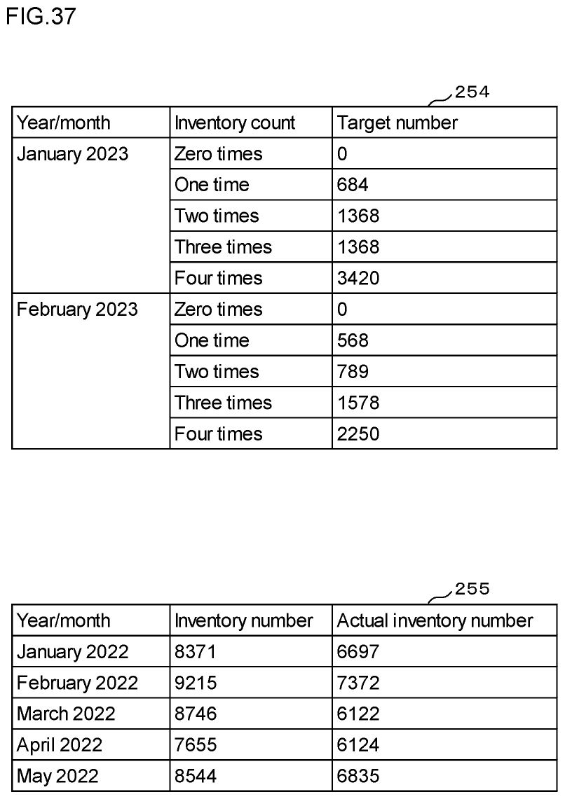

FIG. 37 is an explanatory diagram illustrating an example of a record layout of inventory count DB and inventory management DB;

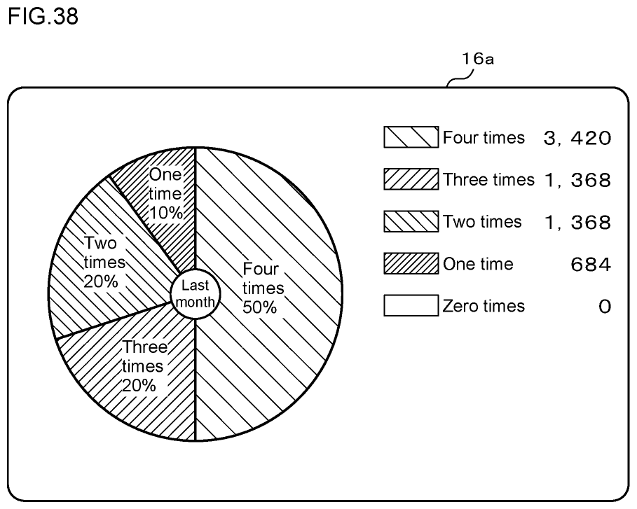

FIG. 38 is an explanatory diagram illustrating an example of a display screen of a second graph;

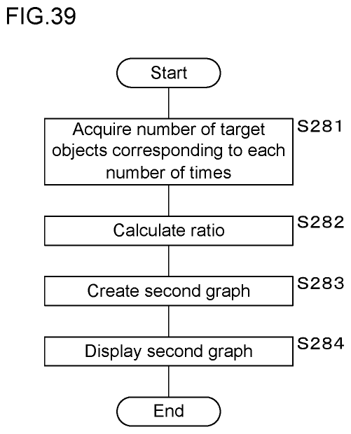

FIG. 39 is a flowchart illustrating a processing procedure for outputting the second graph;

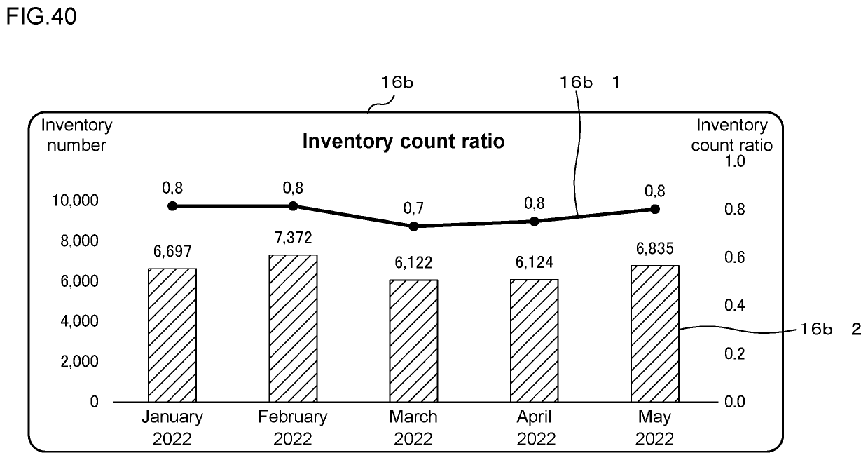

FIG. 40 is an explanatory diagram illustrating an example of a display screen of a third graph;

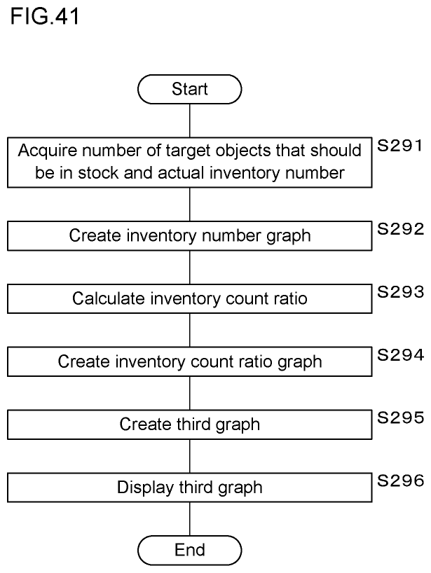

FIG. 41 is a flowchart illustrating a processing procedure for outputting the third graph;

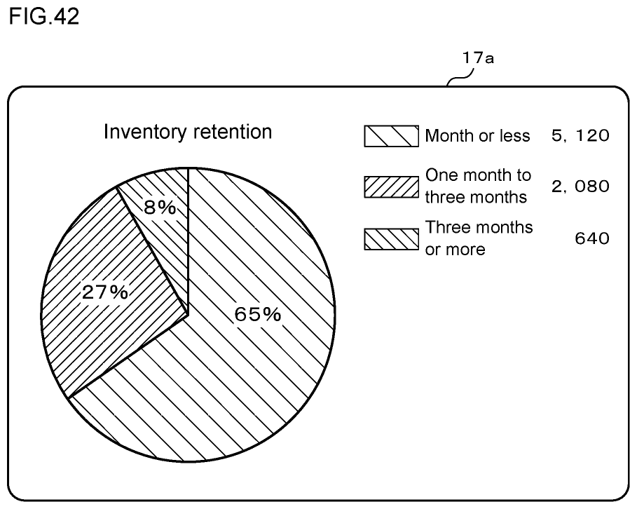

FIG. 42 is an explanatory diagram illustrating an example of a display screen of a fourth graph; and

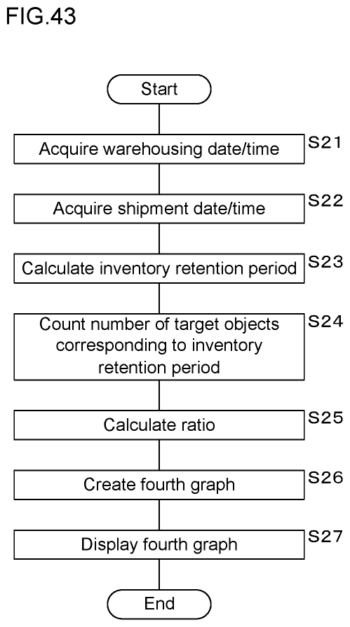

FIG. 43 is a flowchart illustrating a processing procedure for outputting the fourth graph.

Hereinafter, the present invention will be described in detail based on the drawings illustrating the embodiments.

### First Embodiment

A first embodiment relates to a mode in which, each time when an RF tag is read, a read code of the RF tag and a date/time and a work attribute are stored in association with each other.

FIG. 1 is an explanatory diagram illustrating an overview of an RF tag matching system. The system of this embodiment includes an RFID reader 1 and an information processing device 2, and each device transmits and receives information via a network N such as the Internet.

The RFID reader 1 generates electromagnetic waves from an antenna to communicate with the RF tag 20 in a non-contact manner to read (scan) information stored in the RF tag 20. In addition, the RFID reader 1 can read the plurality of RF tags at the same time.

It is noted that an RFID reader/writer may be used instead of the RFID reader 1. The RFID reader/writer not only reads information stored in the RF tag 20 but also writes information to a writable area of the RF tag 20.

It is noted that the RFID reader 1 may be an information processing device such as a smart phone, a mobile phone, a tablet, or a personal computer terminal having a reader function of reading, for example, a code or a two-dimensional code of the RF tag 20. Alternatively, the RFID reader 1 may be an imaging device such as a charge coupled device (CCD) camera or a complementary metal oxide semiconductor (CMOS) camera having a communication function.

The RF tag 20 has an integrated circuit (IC) chip that stores the information and is attached to a target object 10. The target object 10 includes a manufactured product, a product, or a package of the product or the like. The RF tag 20 is used together with the corresponding RFID reader 1 and can transmit data to or receive data from the RFID reader 1 without contact. The RF tag 20 in this embodiment is created by encoding (writing data into the IC chip) a dedicated code (for example, “RFID1”).

The information processing device 2 is an information processing device which processes, stores, and transmits/receives various information. The information processing device 2 is, for example, a server computer (server device), a cloud server device, a personal computer, a general-purpose tablet PC (personal computer), or the like. In this embodiment, the information processing device 2 is assumed to be the server computer, which will be read as and replaced with the server 2 for the brevity below.

The RFID reader 1 according to this embodiment reads the code of the RF tag 20 printed on the surface of the RF tag 20 attached to the target object 10. The RFID reader 1 associates and stores the code, date/time when the reading is performed, and the work attribute of the read RF tag 20. The RFID reader 1 transmits the stored code of each RF tag 20, the stored date/time, and the stored work attribute to the server 2. The server 2 stores the code of each RF tag 20 and the date/time and the work attribute in association with each other.

FIG. 2 is a block diagram illustrating a configuration example of the RFID reader 1. The RFID reader 1 includes a control unit 11, a storage unit 12, a communication unit 13, an input unit 14, a display unit 15, a code reading unit 16, a large-capacity storage unit 17, and an imaging unit 18. Each configuration is connected by a bus B.

The control unit 11 includes an arithmetic processing unit such as a central processing unit (CPU) or a micro-processing unit (MPU) and performs various information processes or control process, and the like related to the RFID reader 1 by reading and executing a control program 1P (program product) stored in the storage unit 12. It is noted that, although it is described in FIG. 2 that the control unit 11 is a single processor, the control unit 11 may be the multiprocessor.

The storage unit 12 includes memory elements such as a random access memory (RAM) and a read only memory (ROM) and stores the control program 1P, data, or the like necessary for the control unit 11 to execute the processes. In addition, the storage unit 12 temporarily stores data and the like necessary for the control unit 11 to execute the arithmetic process. The communication unit 13 is a communication module for performing processes related to communication and performs transmission/reception of information to/from the server 2 or the like via the network N.

The input unit 14 may be a keyboard, a mouse, or a touch panel integrated with the display unit 15. The display unit 15 is a liquid crystal display, an organic electroluminescence (EL) display, or the like and displays various information according to instructions of the control unit 11. The code reading unit 16 is a read-only module for reading the code of the RF tag 20, the two-dimensional code, or the like.

The large-capacity storage unit 17 includes a recording medium such as a hard disk drive (HDD) or a solid state drive (SSD). The large-capacity storage unit 17 stores read information DB (database) 171 and a reference file 172.

The read information DB 171 stores the code of the RF tag 20 read by the RFID reader 1, the reading date/time, the work attribute, and the like. The reference file 172 stores the plurality of RF tags 20 that are read targets. It is noted that the reference files will be described later.

The imaging unit 18 is, for example, the imaging device such as a CCD camera or a CMOS camera. It is noted that the imaging unit 18 may not be built in the RFID reader 1, but may be connected to the RFID reader 1 externally to enable imaging.

FIG. 3 is an explanatory diagram illustrating an example of the record layout of the read information DB 171. The read information DB 171 includes the UID column, the RFID column, the reception column, the inventory count column, and the shipment column.

The work attributes of the target object 10 include reception, inventory count, and shipment. The inventory count is a work of checking how many numbers of inventory remain in the warehouse. In this embodiment, the example of the work attribute including the reception, the inventory count, and the shipment has been described, but the present invention is not limited to this. For example, the work attribute may include inspection and the like.

The UID column stores the ID of any uniquely specified target object 10 to identify each target object 10. In addition, the UID and EPC are set to have the one-to-one relationship. It is noted that the UID may be the same code as the EPC.

It is noted that the UID of the target object 10 may be automatically assigned as the serial number when the RF tag 20 is issued by using software for printing the RF tag 20 or the like. Alternatively, the UID of the target object 10 may be acquired by using the UID data file in which the UIDs are assigned in advance.

The RFID column stores the code of the RF tag 20 read by the RFID reader 1. The reception column includes the reception status column and the reading date/time column. The reception status column stores the reception status of the target object 10. The reception status includes, for example, statuses such as “reception-completed” and “not completed”. The reading date/time column stores the date/time information when the code of the RF tag 20 is read by the RFID reader 1 at the time of reception of the target object 10.

The inventory count column includes the inventory count status column and the reading date/time column. The inventory count status column stores the inventory count status of the target object 10. The inventory count status includes, for example, statuses such as “inventory-count-completed” and “not-completed”. The reading date/time column stores the date/time information when the code of the RF tag 20 is read by the RFID reader 1 at the inventory count time of the target object 10.

The shipment column includes the shipment status column and the reading date/time column. The shipment status column stores the shipment status of the target object 10. The shipment status includes, for example, statuses such as “shipment completed” and “not-completed.” The reading date/time column stores the date/time information when the code of the RF tag 20 is read by the RFID reader 1 at the shipment time of the target object 10.

FIG. 4 is an explanatory diagram illustrating an example of the data configuration of the reference file 172. The reference file 172 storing the plurality of RF tags 20 that are read targets is stored in advance in the large-capacity storage unit 17 of the RFID reader 1. That is, the information about the plurality of RF tags 20 that are read targets by the RFID reader 1 is stored in the reference file 172 and used.

It is noted that, when the second RF tag 20 different from the RF tag 20 included in the reference file 172 already imported into the RFID reader 1 becomes a read target, the reference file 172 including the second RF tag 20 that is a new read target needs to be imported into RFID reader 1.

The reference file 172 stores numbers (No), product management codes, positions, pick lists, electronic product codes (EPCs), and the like. The EPC is a general term for identification codes for writing to electronic tags standardized by international organization for distribution code management and distribution standards (GS1). The number is a number of reading target.

The product management code is, for example, a code uniquely determined according to the manufacturing date or production lot of the target object 10 for each target object 10, and is a code provided to the target object 10 at the manufacturing factory that manufactures the target object 10. The position may be a latitude and longitude of the target object 10, a name of the location, a name of the warehouse, or the like.

The pick list is a list to which the reading (picking) target belongs. The pick list can be set by the vendor under any conditions. As an example, the reception pick list, the inventory count pick list, and the shipment pick list may be set according to the work attribute including the reception, the inventory count, and the shipment.

As illustrated, for the pick list named “PICK1”, all RF tags 20 belonging to “PICK1” are reading targets. Specifically, the RF tag 20 attached to the target object 10 of which product management code is “PART_A_1” and “PART_B_1” is the RF tag 20 to be read belonging to “PICK1”.

It is noted that other items (such as the order number or name of the target object 10) may be stored in the reference file in accordance with actual needs, without limitation to the items described above.

FIG. 5 is a block diagram illustrating a configuration example of the server 2. The server 2 includes a control unit 21, a storage unit 22, a communication unit 23, a reading unit 24, a large-capacity storage unit 25, and a display unit 26. Each configuration is connected by the bus B.

The control unit 21 includes the arithmetic processing unit such as a CPU, an MPU, a graphics processing unit (GPU), a field programmable gate array (FPGA), a digital signal processor (DSP), or a quantum processor. The control unit 21 performs various information processing, control processing and the like related to the server 2 by reading and executing a control program 2P (program product) stored in the storage unit 22.

It is noted that the control program 2P may be arranged to a single computer or located at one site or may be distributed at a plurality of computers and can be loaded to be executed on a plurality of computers interconnected by a communications network. It is noted that, although the control unit 21 is described as the single processor in FIG. 5, the control unit 21 may be the multiprocessor.

The storage unit 22 includes the memory element such as a RAM or a ROM, and stores the control program 2P or data necessary for the control unit 21 to execute processing. The storage unit 22 also temporarily stores data and the like necessary for the control unit 21 to perform arithmetic processing. The communication unit 23 is a communication module for performing processing related to communication, and transmits/receives information to/from the RFID reader 1 or the like via the network N.

The reading unit 24 reads a portable storage medium 2a including a compact disc (CD)-ROM or a digital versatile disc (DVD)-ROM. The control unit 21 may read the control program 2P from the portable storage medium 2a via the reading unit 24 and store the control program 2P in the large-capacity storage unit 25. Alternatively, the control unit 21 may download the control program 2P from another computer via the network N or the like and store the control program 2P in the large-capacity storage unit 25. Furthermore, the control unit 21 may read the control program 2P from a semiconductor memory 2b.

The large-capacity storage unit 25 includes recording medium such as a HDD or an SSD. The large-capacity storage unit 25 contains the management DB 251. The management DB 251 stores the management information about the target object 10. The display unit 26 is a liquid crystal display, an organic EL display, or the like, and displays various information according to instructions from the control unit 21.

In addition, in this embodiment, the storage unit 22 and the large-capacity storage unit 25 may be configured as an integrated storage device. In addition, the large-capacity storage unit 25 may be configured with a plurality of storage devices. Furthermore, the large-capacity storage unit 25 may be an external storage device connected to the server 2.

The server 2 may execute various information processing, control processing, and the like as the single computer, or may be distributed and executed among the plurality of computers. In addition, the server 2 may be implemented by the plurality of virtual machines provided in one server, or may be implemented by using the cloud server.

FIG. 6 is an explanatory diagram illustrating an example of the record layout of the management DB 251. The management DB 251 includes a UID column, the RFID column, a reception column, a inventory count column, and a shipment column. It is noted that each column of the management DB 251 is the same as each column of the read information DB 171, so that the description thereof will be omitted.

It is noted that the storage form of each DB described above is an example, and other storage forms may be used as long as the relationship between data is maintained.

Sequentially, the process of associating and storing the code of the RF tag 20 read, the reading date/time, and the work attribute in an association manner every time the code of the RF tag 20 is read will be described.

FIG. 7 is a flowchart illustrating a processing procedure for transmitting the code, reading date/time, and work attribute. The control unit 11 of the RFID reader 1 reads the code of the RF tag 20 printed on the surface of the RF tag 20 attached to each target object 10 via the code reading unit 16 (step S101). The control unit 11 receives an input of the work attribute of the target object 10 through the input unit 14 (step S102). It is noted that the work attribute can be specified based on the pick list described later.

The control unit 11 associates the read code of the RF tag 20 with the reading date/time and the work attribute, and stores the read code of the RF tag 20, the reading date/time and the work attribute in the read information DB 171 of the large-capacity storage unit 17 (step S103). Specifically, the control unit 11 associates the UID of the target object 10 and the read code of the RF tag 20, and stores the work attribute status and the reading date/time in the reading information DB 171. For example, when the work attribute is in a reception, the control unit 11 associates the UID of the target object 10 and the code of the RF tag 20, and stores the reception status that is “reception-completed” and the reading date/time in the read information DB 171.

The control unit 11 transmits the stored UID of the target object 10, the code of the RF tag 20, the reading date/time, and the work attribute to the server 2 through the communication unit 13 (step S104). The control unit 21 of the server 2 receives the UID of the target object 10, the code of the RF tag 20, the reading date/time, and the work attribute transmitted from the RFID reader 1 through the communication unit 23 (step S201).

The control unit 21 associates the received code of the RF tag 20 with the reading date/time and the work attribute, and stores the code of the RF tag 20, the reading date/time and the work attribute in the management DB 251 of the large-capacity storage unit 25 (step S202). The control unit 21 ends the process. Specifically, the control unit 21 associates the received UID of the target object 10 and the code of the RF tag 20, and stores the work attribute status and the reading date/time in the management DB 251.

Next, the process of determining whether the reading of the RF tag 20 is excessive or insufficient by using the reference file 172 will be described. First, the process of accepting the selection of items in the reference file 172 will be explained.

FIG. 8 is an explanatory diagram illustrating an example of the screen for accepting the selection of items in the reference file 172. The screen includes a list display column 11a, a product management code selection column 11b, a position selection column 11c, a pick list selection column 11d, and an EPC selection column 11e.

The list display column 11a is a display column displaying a list of the plurality of RF tags 20 included in the reference file 172. The product management code selection column 11b is a selection column accepting selection of the product management code. The position selection column 11c is a selection column accepting selection of the position. The pick list selection column 11d is a selection column accepting selection of the pick list. The EPC selection column 11e is a selection column accepting selection of the EPC.

The RFID reader 1 stores the reference file 172 storing the plurality of RF tags 20 that are read targets in the large-capacity storage unit 17 in advance. The RFID reader 1 refers to the reference file 172 stored in the large-capacity storage unit 17 and reads the plurality of RF tags 20 and the items of each RF tag 20 in the reference file 172. The RFID reader 1 displays the plurality of read RF tags 20 and the items of each RF tag 20 in the list display column 11a.

As illustrated, for each RF tag 20 to be read, items including the number (No), the product management code, the position, the pick list, and the EPC are displayed in the list display column 11a. It is noted that the items are not limited to those described above, and other items (order number, name, and the like) may be used according to actual needs.

The RFID reader 1 accepts selection of item types in the reference file 172 by the vendor (user). The item type is the detailed classification for the item. For example, the position item types include “LOC_X” and “LOC_Y”, and the pick list item types include “PICK1” and “PICK2”. Each of the “LOC_X” and the “LOC_Y” indicates the different position or the warehouse name. The “PICK1” and “PICK2” indicate, for example, the reception pick list and the inventory count pick list, respectively.

For example, when the RFID reader 1 accepts the selection operation of the position selection column 11c, the RFID reader 1 accepts the selection of the type (for example, “LOC_X” or “LOC_Y”) of the position item by the vendor. The RFID reader 1 specifies the RF tag 20 that should be read corresponding to the selected position item (for example, “LOC_X”). The RFID reader 1 displays the list of the specified RF tags 20 to be read on the list display column 11a.

Alternatively, when the RFID reader 1 accepts the selection operation of the pick list selection column 11d, the RFID reader 1 accepts the selection of the type (for example, “PICK1” or “PICK2”) of the pick list item by the vendor. The RFID reader 1 specifies the RF tag 20 that should be read corresponding to the selected pick list item (for example, “PICK1”). The RFID reader 1 displays the list of the specified RF tags 20 to be read on the list display column 11a.

It is noted that, when there are a plurality of the reference files 172, the RFID reader 1 accepts selection of the reference file 172 by the vendor from a plurality of the reference file 172. The RFID reader 1 refers to the selected reference file 172 and reads the items of the plurality of RF tags 20 and each RF tag 20 in the reference file 172.

Next, the process of determining whether the reading of the RF tag 20 is excessive or insufficient based on the reference file 172 will be described.

FIGS. 9A, 9B, and 9C are explanatory diagrams illustrating examples of determination results of excessive and insufficient reading of the RF tag 20. FIG. 9A is an explanatory diagram illustrating an example of the reading success screen of the RF tag 20. FIG. 9B is an explanatory diagram illustrating an example of the reading failure screen of the RF tag 20. FIG. 9C is an explanatory diagram illustrating an example of the over-reading screen of the RF tag 20.

The screen includes an RFID button 12a. The RFID button 12a is a button for reading the code of the RF tag 20. When the RFID button 12a is touched (clicked), the RFID reader 1 reads the code of the RF tag 20 printed on the surface of the RF tag 20 attached to each target object 10. The code of the RF tag 20 contains EPC.

The RFID reader 1 compares the read RF tag 20 with the tag of the RF tag 20 to be read corresponding to the item (for example, PICK1) selected from the reference file 172, and, determines whether the RF tag 20 is read excessively or insufficiently. The RFID reader 1 displays the determined determination result on the screen.

Specifically, when the EPC included in the code of the read RF tag 20 is stored in the reference file 172, the RFID reader 1 determines that the reading is successful. After reading all the RF tags 20 that are read targets, the RFID reader 1 determines whether or not the number of read RF tags 20 and the number of RF tags 20 to be read corresponding to the item (for example, PICK1) selected from the reference file 172 match each other.

When the two numbers match, the RFID reader 1 displays the message indicating that the reading succeeds and the read number of RF tags 20 is included. As illustrated in FIG. 9A, “54” as the number of RF tags 20 and the message including “scan complete!” are displayed on the screen.

When the EPC included in the read code of the RF tag 20 is not stored in the reference file 172, the RFID reader 1 determines that the reading fails. In this case, the RFID reader 1 outputs information indicating that the RF tag 20 is not a read target. As illustrated in FIG. 9B, the message “other items detected!” is displayed on the screen. It is noted that the RFID reader 1 may output an alert indicating that the item is different from the item in the reference file 172 on the screen.

When the number of read RF tags 20 exceeds the number of RF tags 20 to be read, the RFID reader 1 displays the message indicating that the number of read RF tags 20 exceeds. As illustrated in FIG. 9C, the message “scan quantity exceeded!” is displayed on the screen.

When the number of read RF tags 20 is less than the number of RF tags 20 to be read, the RFID reader 1 displays the message indicating that the number of read RF tags 20 is insufficient. For example, the message (not illustrated) that is “scan quantity insufficient!” may be displayed. It is noted that the RFID reader 1 counts the number of unread RF tags 20 from the reference file 172. The RFID reader 1 may display the counted number of unread RF tags 20 together with the message on the screen.

FIG. 10 is a flowchart illustrating a processing procedure for determining whether the reading of the RF tag 20 is excessive or insufficient. The control unit 11 of the RFID reader 1 acquires the reference file 172 storing a plurality of the RF tags 20 that are reading targets (step S111). For example, the control unit 11 may download the reference file 172 through the communication unit 13 from the RF tag matching system of this embodiment. The control unit 11 stores the acquired reference file 172 in the large-capacity storage unit 17 (step S112).

It is noted that, once the above-described processes (steps S111 to S112) are executed, execution of the process from the next time can be omitted.

The control unit 11 refers to the reference file 172 stored in the large-capacity storage unit 17 and reads the plurality of RF tags 20 in the reference file 172 and the items (number, product management code, position, pick list, EPC, and the like) of each RF tag 20 (step S113).

The control unit 11 displays the list of the read plurality of RF tags 20 and the items of each RF tag 20 via the display unit 15 (step S114). The control unit 11 receives the selection of the item in the reference file 172 and the type of the item by the vendor through the input unit 14 (step S115). The control unit 11 allows the display unit 15 to display the list of RF tags 20 to be read corresponding to the selected item and the type of the item (step S116).

The control unit 11 executes the subroutine of the process for determining whether the reading of the RF tag 20 is excessive or insufficient (step S117). It is noted that the subroutine for determining whether reading is excessive or insufficient will be described later. The control unit 11 performs an update process of the reference file 172 by deleting the read RF tag 20 from the reference file 172 (step S118). The control unit 11 displays the determined determination result on the display unit 15 (step S119) and ends the process.

It is noted that it is not limited to the update timing of the reference file 172 mentioned above. For example, a batch process may be performed every predetermined period (for example, one day).

It is noted that the selection of items in the reference file 172 may be not necessary, and may read all RF tags 20 included in the reference file 172. In this case, the control unit 11 omits execution of the processes of steps S115 to S116 and the process of step S118 (the process of updating the reference file 172). After that, the control unit 11 executes the process of step S104 in FIG. 7.

FIG. 11 is a flowchart illustrating a processing procedure of a subroutine of a procedure for determining whether the RF tag 20 is excessive or insufficient. The control unit 11 of the RFID reader 1 reads the code of the RF tag 20 attached to the target object 10 through the code reading unit 16 (step S01). The control unit 11 determines whether or not the EPC included in the read code of the RF tag 20 is stored in the reference file 172 (step S02).

When the EPC included in the code of the RF tag 20 is not stored in the reference file 172 (NO in step S02), the control unit 11 determines that the reading fails (step S03). The control unit 11 allows the display unit 15 to display the message that the code is not a reading target (step S04). When the EPC included in the code of the RF tag 20 is stored in the reference file 172 (YES in step S02), the control unit 11 determines that the reading succeeds (step S05).

The control unit 11 determines whether or not the reading of the code of all the RF tags 20 that are reading targets is completed (step S06). When the reading of the code of all the RF tags 20 that are read targets has not been completed (NO in step S06), the control unit 11 returns to the process of step S01.

When the reading of the code of all the RF tags 20 that are read targets is completed (YES in step S06), the control unit 11 determines whether or not the number of read RF tags 20 and the number of RF tags 20 to be read corresponding to the items selected from the reference file 172 match each other (step S07).

When the two numbers match (YES in step S07), the control unit 11 displays the successfully read message on the display unit 15 (step S08). The control unit 11 ends the subroutine for determining excess or insufficiency of reading and returns. The control unit 11 determines whether or not the number of read RF tags 20 exceeds the number of RF tags 20 to be read (step S09).

When the number of read RF tags 20 exceeds the number of RF tags 20 to be read (YES in step S09), the control unit 11 allows the display unit 15 to display the message indicating that the number of read RF tags 20 has been exceeded (step S10). The control unit 11 ends the subroutine for determining excess or insufficiency of reading and returns.

When the number of read RF tags 20 is less than the number of RF tags 20 to be read (NO in step S09), the control unit 11 allows the display unit 15 to display the message indicating that the number of read RF tags 20 is insufficient (step S11). The control unit 11 ends the subroutine for determining excess or insufficiency of reading and returns.

According to this embodiment, every time the RFID reader 1 reads the code of the RF tag 20, it is possible to store the read code of the RF tag 20 in association with the reading date/time and the work attribute.

According to this embodiment, it is possible to refer to the reference file 172 and determine whether the RF tag 20 has been read excessively or insufficiently.

According to this embodiment, by using the reference file 172, it is possible to determine whether the reading of the RF tag 20 is excessive or insufficient only by the RFID reader 1 without depending on the specific network environment.

According to this embodiment, when the RF tag 20 is the RF tag 20 not stored in the reference file 172, it is possible to output information indicating that the tag is not a read target.

### Second Embodiment

the second embodiment relates to a mode in which the first code of the two-dimensional code attached to the target object 10 is converted into a second code, and the converted second code is set as the code of the RF tag 20. It is noted that, description about the content which overlaps with the first embodiment is omitted.

The two-dimensional code may be, for example, a QR code (registered trademark) of the display mode having information in the horizontal and vertical directions, as opposed to a one-dimensional code that has information only in the horizontal direction. The one-dimensional code may be, for example, the bar code that represents numerical values or characters by a thickness of striped lines. In this embodiment, the example of the two-dimensional code has been described, it is not limited to this and can be applied to the one-dimensional code as well.

The RF tag 20 is encoded on the spot based on the two-dimensional code attached to the target object 10, and the encoded RF tag 20 is issued. The issued RF tag 20 is attached to the target object 10. However, when the code size of the two-dimensional code that is the encoding source is large, there is a possibility that the code cannot be encoded because it cannot be accommodated in the memory capacity of the code of the RF tag 20 that is the encoding destination. In this embodiment, the above problem can be solved by performing the code conversion process on the code of the two-dimensional code that is the encoding source.

FIG. 12 is an explanatory diagram illustrating the code conversion process. As illustrated, the two-dimensional code 19 is attached to the target object 10. Moreover, in FIG. 12, the printing device 3 is included. The printing device 3 is a printing device that prints the RF tag 20 and the like.

The RFID reader 1 acquires the first code of the two-dimensional code 19 by reading the two-dimensional code 19. The RFID reader 1 converts the acquired first code into the second code that is shorter than the first code.

Specifically, the RFID reader 1 converts the acquired first code into the second code shorter than the first code by using, for example, the hash function of the message digest (MD) 5. The hash function of the MD 5 is one of hash functions (summarization functions) that generates the 128-bit value based on the encoding source (original text) with an arbitrary length.

By using the hash function of the MD 5, the encoding source is converted to 128 bits regardless of the size of the encoding source, and thus, any RFID reader 1 having a memory capacity of 128 bits or more can be used. It is noted that the code conversion process is not limited to the hash function such as the MD 5 described above, and the code conversion process algorithm capable of converting to the second code shorter than the first code other than the hash function may be used.

The RFID reader 1 sets the converted second code as the code of the RF tag 20. The RFID reader 1 issues the RF tag 20 having the set code so as to be attached to the target object 10.

Specifically, the RFID reader 1 uses, for example, the software for printing the RF tag 20 and sets the converted second code as the code of the RF tag 20. The RFID reader 1 transmits print information (print data, number of prints, and the like) of the RF tag 20 having the set code to the printing device 3 through the software for printing the RF tag 20.

The printing device 3 receives the printing information of the RF tag 20 transmitted from the RFID reader 1. The printing device 3 prints the RF tag 20 based on the received print information of the RF tag 20. The vendor attaches the printed RF tag 20 to the target object 10.

FIG. 13 is a flowchart illustrating a processing procedure when the code conversion process is performed. The control unit 11 of the RFID reader 1 reads the two-dimensional code 19 attached to the target object 10 via the code reading unit 16 (step S121). The control unit 11 acquires the first code of the two-dimensional code 19 from the read two-dimensional code 19 (step S122). The control unit 11 converts the acquired first code into the second code shorter than the acquired first code, for example, by using the MD 5 hash function (step S123).

The control unit 11 uses, for example, software for printing the RF tag 20, and sets the converted second code as the code of the RF tag 20 (step S124). The control unit 11 generates print information (print data, number of print sheets, and the like) of the RF tag 20 having the set code through the software for printing the RF tag 20 (step S125). The control unit 11 transmits the generated print information of the RF tag 20 to the printing device 3 through the communication unit 13 (step S126). The control unit 11 ends the process.

According to this embodiment, the second code converted from the first code of the two-dimensional code attached to the target object 10 can be set as the code of the RF tag 20.

According to this embodiment, by the code conversion process for the two-dimensional code, the two-dimensional code used on the system side is used as it is, and thus, the modification of the system is not necessary, so that the reduction of the operating costs can be intended.

### Third Embodiment

A third embodiment relates to a mode in which the two-dimensional code attached to the target object 10 and the two-dimensional code corresponding to the code of the RF tag 20 attached to the target object 10 are associated and stored. It is noted that the description of the contents overlapping with those of the first and second embodiments will be omitted.

FIG. 14 is an explanatory diagram illustrating an example of a record layout of the read information DB 171 according to the third embodiment. It is noted that, the content which overlaps with FIG. 3 is denoted by the same reference numeral, and the description is omitted. The read information DB 171 includes the first two-dimensional code column and the second two-dimensional code column.

The first two-dimensional code column stores the code of the first two-dimensional code attached to the target object 10. The second two-dimensional code column stores the code of the second two-dimensional code corresponding to the code of the RF tag 20 printed on the surface of the RF tag 20 attached to the target object 10.

FIG. 15 is an explanatory diagram illustrating a process of associating and storing the code of the first two-dimensional code and the code of the second two-dimensional code. The screen includes the RF tag 20, the first two-dimensional code 31, and the second two-dimensional code 32. The first two-dimensional code 31 is a two-dimensional code (original code) attached to the target object 10. The second two-dimensional code 32 is a two-dimensional code corresponding to the code of the RF tag 20. That is, the code of the RF tag 20 and the code of the second two-dimensional code 32 match with each other.

The RFID reader 1 reads first two-dimensional code 31 attached to target object 10. The RFID reader 1 acquires the code of the first two-dimensional code 31 from the read first two-dimensional code 31.

RFID reader 1 reads the second two-dimensional code 32 corresponding to the code of RF tag 20. The RFID reader 1 acquires the code of the second two-dimensional code 32 from the read second two-dimensional code 32.

The RFID reader 1 stores the read code of the first two-dimensional code 31 and the read code of the second two-dimensional code 32 in the read information DB 171 in association with the code of the first two-dimensional code 31 and the code of the second two-dimensional code 32. Specifically, the RFID reader 1 associates the read code of the first two-dimensional code 31, the read code of the second two-dimensional code 32, and the code of the RF tag 20 that matches the code of the second two-dimensional code 32, and stores the afore-mentioned codes in the read information DB 171.

FIG. 16 is a flowchart illustrating a processing procedure when the code of the first two-dimensional code and the code of the second two-dimensional code are stored in association with each other. The control unit 11 of the RFID reader 1 uses the code reading unit 16 to read the first two-dimensional code attached to the target object 10 (step S131). The control unit 11 acquires the code of the first two-dimensional code from the read first two-dimensional code (step S132).

The control unit 11 reads the second two-dimensional code corresponding to the code of the RF tag 20 by the code reading unit 16 (step S133). The control unit 11 acquires the code of the second two-dimensional code from the read second two-dimensional code (step S134).

The control unit 11 stores the code of the first two-dimensional code and the code of the second two-dimensional code in association with each other in the read information DB 171 of the large-capacity storage unit 17 (step S135). The control unit 11 ends the process. It is noted that the data in which the code of the first two-dimensional code and the code of the second two-dimensional code may be stored in association with each other on the server 2 side.

Since the code of the RF tag 20 and the code of the second two-dimensional code 32 match each other, by performing the process described above, the code of the RF tag 20, the code of the first two-dimensional code 31, and the code of the second two-dimensional code 32 are stored in the read information DB 171 in association with each other.

According to this embodiment, the two-dimensional code attached to the target object 10 and the two-dimensional code corresponding to the code of the RF tag 20 attached to the target object 10 can be associated and stored.

According to this embodiment, when the RF tag 20 associated with the two-dimensional code is attached to the target object 10, the workload can be reduced because visual comparison with the two-dimensional code is unnecessary.

According to this embodiment, since radio waves are not necessary, it is possible to prevent the original code (first two-dimensional code 31) and the two-dimensional code (second two-dimensional code 32) corresponding to the code of the RF tag 20 from linking error.

### Fourth Embodiment

In a mode of a fourth embodiment, information about the target object 10 is acquired by reading the two-dimensional code corresponding to the code of the RF tag 20 attached to the target object 10, and the report file is created based on the acquired information about the target object 10. It is noted that the description of the contents overlapping with those of the first to third embodiments will be omitted.

FIG. 17 is an explanatory diagram illustrating an overview of the RF tag matching system according to the fourth embodiment. It is noted that the contents overlapping with FIG. 1 are denoted by the same reference numeral, and the description is omitted.

As illustrated in the figure, the RF tag 20 printed with the two-dimensional code corresponding to the code of the RF tag 20 is attached to the target object 10. An EPC number 201 and the two-dimensional code 202 including the EPC number 201 are printed on the surface of the RF tag 20. It is noted that the information printed on the surface of the RF tag 20 is not limited to the items described above, and may be arbitrary characters, numbers, or the like.

FIG. 18 is a block diagram illustrating a configuration example of the server 2 according to the fourth embodiment. It is noted that the contents overlapping with FIG. 5 are denoted by the same reference numeral, and the description is omitted. The large-capacity storage unit 25 includes target object information DB 252. The target object information DB 252 stores the information about the target object 10. It is noted that information about the target object 10 will be described later.

FIG. 19 is an explanatory diagram illustrating an example of the record layout of the target object information DB 252. The target information DB 252 includes the UID column, a target object image column, a name column, a model number column, a two-dimensional code column, an EPC column, a size column, a damage size column, a damage level column, a damage factor column, a damage image column, and a work type column, a vendor column, a warehouse column, and an occurrence date/time column.

The UID column stores the UID of the target object 10 for specifying the target object 10. The target object image column stores the image data of the target object 10 such as a packing image. The name column stores the name of the target object 10. The model number column stores the model number of the target object 10. The two-dimensional code column stores the two-dimensional code 202 printed on the surface of the target object 10. The EPC column stores the EPC included in the two-dimensional code 202.

The size column stores the size data of the target object 10. The damage size column stores the damage size data of the target object 10. The damage level column stores the damage level of the target object 10. It is noted that the damage level will be described later. The damage factor column stores damage factors such as breakage, crush, dirt, or dent. The damage image column stores damage image data obtained by imaging the damaged portion of the target object 10.

The work type column stores work types including the time of reception and the time of transportation by the lifter. The vendor column stores the information specifying the vendor, such as the ID or name of the vendor who performed the work on the target object 10. The warehouse sequence stores the information specifying (identifying) the warehouse such as the ID or name of the warehouse storing the target object 10. The occurrence date/time column stores date/time information when the damage to the target object 10 occurs.

The RFID reader 1 acquires the code of the two-dimensional code 202 by reading the two-dimensional code 202 corresponding to the code of the RF tag 20. The code of the two-dimensional code contains the EPC of the target object 10.

The RFID reader 1 acquires the UID of the target object 10. For example, when the UID of the target object 10 is configured as a portion of the EPC, the RFID reader 1 acquires the UID of the target object 10 from the EPC included in the acquired code of the two-dimensional code 202. It is noted that the UID of the target object 10 can be acquired by using the UID data file to which the UID is assigned in advance. For example, when the RFID reader 1 reads the RF tag 20 attached to the target object 10 for the first time, the RFID reader 1 may acquire the UID from the data file.

The RFID reader 1 acquires the information about the target object 10. The information about the target object 10 includes the image data, the name, the model number, the size data, the damage information about the damage, the image, and the like of the target object 10.

Specifically, the RFID reader 1 receives input such as the name and the model number, the type of work (at the time of reception or at the time of transportation, and the like) of the target object 10, the name of the vendor who performs the work on the target object 10, and the name of the warehouse where the target object 10 is stored. It is noted that the name and the model number of the target objects 10 may be described in the code of the two-dimensional code 202 in association with the EPC of the target object 10. The RFID reader 1 acquires the image data of the target object 10 via the imaging unit 18.

The RFID reader 1 measures the size (vertical dimension, lateral dimension, and height) of the target object 10. For example, when the light detection and ranging (LiDAR) sensor is mounted on the RFID reader 1, the RFID reader 1 measures the size of the target object 10 by using the LiDAR sensor. It is noted that the measurement of the size of the target object 10 is not limited to the LiDAR sensor. For example, the vendor may manually measure the size of the target object 10.

The RFID reader 1 acquires the damage information about the damage to the target object 10. The damage information includes, for example, the damage size, the damage level, the damage factor (for example, the breakage, the crush, the dirt, or the dent), or the damage image data.

As for the damage level, the plurality of levels may be set in advance according to the damage size or the like. In this embodiment, the damage level L (small), the damage level M (medium), and the damage level H (large) are set as the damage levels. For example, when the damage size is less than “L: 5 cm×W: 5 cm”, the damage level is set to the damage level L. Alternatively, when the damage size is “L: 5 cm×W: 5 cm” or more and less than “L: 10 cm×W: 10 cm”, the damage level is set to the damage level M. Alternatively, when the damage size is “L: 10 cm×W: 10 cm” or more, the damage level is set to the damage level H. It is noted that the damage level may be set freely, and may be set, for example, 10 levels from level 0 to level 9.

For example, the RFID reader 1 measures the damage size of the target object 10 by using the LiDAR sensor. The RFID reader 1 receives the inputs such as the damage level and the damage factor from the vendor according to the measured damage size.

The damage information may be acquired by using the learning model learned by machine learning, the deep learning, or the like. For example, when the damage image indicating the damage to the target object 10 is input, the RFID reader 1 may acquire the damage level and the damage factor by using the learning-completed learning model to output the damage level and the damage factor of the target object 10.

The RFID reader 1 acquires the damage image data including the damaged area of the target object 10 via the imaging unit 18.

The RFID reader 1 transmits the two-dimensional code 202 of the target object 10, the code (EPC) of the two-dimensional code 202, and the information about the target object 10 to the server 2 in association with the acquired UID of the target object 10. The information about the target object 10 includes the image data, the name, the model number, the size data, and the damage information (damage size, damage level, damage image, and the like) about the damage and the like of the target object 10.

The server 2 receives the UID of the target object 10, the two-dimensional code 202 of the target object 10, the code of the two-dimensional code 202, and the information about the target object 10 transmitted from the RFID reader 1. The server 2 stores the two-dimensional code 202 of the target object 10, the code of the two-dimensional code 202, and the information about the target object 10 in the target object information DB 252 in association with the received UID of the target object 10.

FIG. 20 is a flowchart illustrating a processing procedure for transmitting information about the target object 10 to the server 2. The control unit 11 of the RFID reader 1 reads the two-dimensional code 202 corresponding to the code of the RF tag 20 attached to the target object 10 via the code reading unit 16 (step S141). The control unit 11 acquires the EPC (the code of the two-dimensional code 202) of the target object 10 from the read two-dimensional code 202 (step S142).

The control unit 11 accepts an input of the name and the model number of the target objects 10 by the input unit 14 (step S143). It is noted that an input of other items (for example, product type) may be accepted without being limited to the name and the model number of the target object 10. The control unit 11 acquires the image data of the target object 10 via the imaging unit 18 (step S144).

The control unit 11 measures the size of the target object 10 by using, for example, the LiDAR sensor mounted on the RFID reader 1 (step S145). The control unit 11 acquires the measured size data of the target object 10 (step S146).

The control unit 11 acquires the damage information about the damage to the target object 10 (step S147). The damage information includes the damage size, the damage level, the damage factor, the damage image data, and the like. The damage information may be acquired by, for example, the LiDAR sensor or the learning model learned based on the machine learning or the like.

The control unit 11 transmits the acquired UID of the target object 10, the two-dimensional code 202, the EPC, and the information about the target object 10 to the server 2 through the communication unit 13 (step S148). The information about the target object 10 includes the image data, the name, the model number, the size data, and the damage information (damage size, damage level, damage factor, damage image, and the like) about the damage and the like of the target object 10.

The control unit 21 of the server 2 receives the UID of the target object 10, the two-dimensional code 202, the EPC, and the information about the target object 10 transmitted from the RFID reader 1 through the communication unit 23 (step S241). The control unit 21 stores the two-dimensional code 202 of the target object 10, the EPC, and the information about the target object 10 in association with the received UID of the target object 10 in the target object information DB 252 of the large-capacity storage unit 25 (step S242). The control unit 21 ends the process.

Next, the process of creating the report file based on the information about the target object 10 will be described.

FIG. 21 is a flowchart illustrating a processing procedure at the time of creating the report file. The control unit 11 of the RFID reader 1 transmits the UID of the target object 10 to the server 2 through the communication unit 13 (step S151). The control unit 21 of the server 2 receives the UID of the target object 10 transmitted from the RFID reader 1 through the communication unit 23 (step S251).

The control unit 21 acquires the information for creating the report file including the two-dimensional code 202 corresponding to the code of the RF tag 20 attached to the target object 10, the code 201 (EPC number 201) of the two-dimensional code 202, and the information about the target object 10 from the target object information DB 252 of the large-capacity storage unit 25 (step S252) based on the received UID of the target object 10.

The information about the target object 10 includes the image data, the name, the model number, the size data, the damage size, the damage level, the damage factor, the damage image data, and the like of the target object 10. The control unit 21 creates the report file based on the acquired information for creating the report file (step S253). The control unit 21 allows the display unit 26 to display (output) the created report file (step S254). The control unit 21 ends the process. It is noted that the process of creating and displaying the report file may be executed on the RFID reader 1 side.

FIG. 22 is an explanatory diagram illustrating an example of the report file. The report file includes an EPC display column 13a, a basic information display column 13b, a size display column 13c, a damage information display column 13d, and an image display column 13e.

The EPC display column 13a is a display column displaying the two-dimensional code 202 corresponding to the code of the RF tag 20, the EPC number 201 included in the two-dimensional code 202, and the like. The basic information display column 13b column is a display column displaying basic information such as the name and the model number of the target objects 10.

The size display column 13c is a display column displaying the size data of the target object 10. The damage information display column 13d is a display column displaying the damage information about the target object 10. The image display column 13e is a display column displaying the image data of the target object 10.

The server 2 acquires the information for creating the report file including the two-dimensional code 202 corresponding to the code of the RF tag 20 attached to the target object 10, the EPC number 201, and the information about the target object 10 from the target object information DB 252 based on the UID of the target object 10. The information about the target object 10 includes the image data, the name, the model number, the size data, the damage size, the damage level, the damage factor, and the damage image data of the target object 10.

The server 2 creates the report file based on the acquired two-dimensional code 202, the EPC, and information about the target object 10. The server 2 displays the created report file on the screen.

As illustrated, in the report file, the EPC number 201 and the two-dimensional code 202 are displayed in the EPC display column 13a, and the name and the model number are displayed in the basic information display column 13b. In addition, the size data of the target object 10 is displayed in the size display column 13c, and the damage image data, the damage size, damage level and factor of the target object 10 are displayed in the damage information display column 13d. In addition, the image data of the target object 10 is displayed in the image display column 13e.

It is noted that the format of the report file and the items in the report file are not limited to those described above. The format and items of the report file may be appropriately set according to the type of the target object 10 and the like.

Next, a process outputting the graph based on the damage information about the target object 10 will be described.

The server 2 acquires the damage information about the damage of the target object 10 attached with the RF tag 20 from the target object information DB 252. The damage information includes the work type and the vendor when the damage occurs, the warehouse storing the target object 10, the date/time when the damage occurs, and the like.

The server 2 creates the fifth graph indicating the number of target objects 10 to which damage occurs per unit period (for example, month) for each work based on the acquired damage information. The server 2 creates a sixth graph indicating the number of target objects 10 to which damage occurs per unit period for each vendor based on the acquired damage information.

The server 2 creates a seventh graph indicating the number of target objects 10 to which damage occurs per unit period for each warehouse based on the acquired damage information. The server 2 displays (outputs) at least one of the created fifth, sixth and seventh graphs on the screen.

FIG. 23 is an explanatory diagram illustrating an example of the display screen of the fifth graph. The screen includes the fifth graph display column 18a. The fifth graph display column 18a is a display column displaying the fifth graph.

The server 2 acquires the damage information including the type of work when damage occurs to the target object 10 and the date/time when the damage occurs from the target object information DB 252. The server 2 counts the number of target objects 10 to which damage occurs per unit period (for example, month) for each work based on the acquired work type and the acquired occurrence date/time. The server 2 creates the fifth graph based on the counted count result. The server 2 displays the created fifth graph in the fifth graph display column 18a.

As illustrated, the fifth graph is illustrated in a form of the stacked vertical bar graph. The horizontal axis of the fifth graph indicates the unit period (for example, January to December), and the vertical axis indicates the number of target object 10 to which damage occurs. A breakdown on the vertical axis of the fifth graph is the number of target object 10 to which damage occurs corresponding to each of “at the time of reception”, “at the time of transportation”, and “others”. The “at the time of reception” is exemplarily indicated by hatching with diagonal lines rising to the right. The “at the time of transportation” is exemplarily indicated by hatching with diagonal lines falling to the right. “others” is exemplarily indicated without hatching.

As illustrated, in the fifth graph, the number of target object 10 to which damage occurs corresponding to each of “at the time of reception”, “at the time of transportation”, and “others” by month from January to December is displayed.

FIG. 24 is an explanatory diagram illustrating an example of the display screen of the sixth graph. The screen includes a sixth graph display column 18b. The sixth graph display column 18b is a display column displaying the sixth graph.

The server 2 acquires the damage information including the vendor when the damage to the target object 10 occurs and the occurrence date/time of the damage from the target object information DB 252. The server 2 counts the number of target object 10 to which damage occurs for each unit period (for example, month) for each vendor based on the acquired vendor and the acquired occurrence date/time. The server 2 creates the sixth graph based on the counted count result. The server 2 displays the created sixth graph in the sixth graph display column 18b.

As illustrated, the sixth graph is illustrated in a form of the stacked vertical bar graph. The horizontal axis of the sixth graph indicates the unit period (for example, January to December), and the vertical axis indicates the number of target object 10 to which damage occurs. The breakdown on the vertical axis of the sixth graph is the number of target object 10 to which damage occurs corresponding to each vendor (for example, vendor A, vendor B, and vendor C). The “vendor A” is exemplarily indicated by hatching with diagonal lines rising to the right. The “vendor B” is exemplarily indicated by hatching with diagonal lines falling to the right. The “vendor C” is illustratively illustrated without hatching.

As illustrated, in the sixth graph, the number of target object 10 to which damage occurs corresponding to each of the “vendor A”, the “vendor B”, and the “vendor C” by month from January to December is displayed.

FIG. 25 is an explanatory diagram illustrating an example of the display screen of the seventh graph. The screen includes a seventh graph display column 18c. The seventh graph display column 18c is a display column displaying the seventh graph.

The server 2 acquires the damage information including the warehouse storing the target object 10 to which the damage occurs and the occurrence date/time of the damage from the target object information DB 252. The server 2 counts the number of target objects 10 to which damage occurs per unit period (for example, month) for each warehouse based on the acquired warehouse and the acquired occurrence date/time. The server 2 creates the seventh graph based on the counted count result. The server 2 displays the created seventh graph in the seventh graph display column 18c.

As illustrated, the seventh graph is illustrated in a form of the stacked vertical bar graph. The horizontal axis of the seventh graph indicates the unit period (for example, January to December), and the vertical axis indicates the number of target object 10 to which damage occurs. The breakdown on the vertical axis of the seventh graph is the number of target object 10 to which damage occurs corresponding to each warehouse (for example, a warehouse AA, a warehouse BB, and a warehouse CC). The “warehouse AA” is illustratively indicated by hatching with diagonal lines rising to the right. The “warehouse BB” is exemplarily indicated by hatching with diagonal lines falling to the right. The “warehouse CC” is illustratively illustrated without hatching.

As illustrated in the figure, the seventh graph shows the number of target object 10 to which damage occurs corresponding to each of the “warehouse AA”, the “warehouse BB”, and the “warehouse CC” by month from January to December is displayed.

It is noted that the fifth, sixth, and seventh graphs described above are in a form of the stacked vertical bar graph, but are not limited to this, and may be in another graph form (for example, stacked horizontal bar graph or circle graph).

FIG. 26 is a flowchart illustrating a processing procedure outputting the graph based on the damage information about the target object 10. The control unit 21 of the server 2 acquires the damage information including the work type and the vendor when the damage occurs, the warehouse where the target object 10 is stored, and the date/time when the damage occurs from the target object information DB 252 of the large-capacity storage unit 25 (step S41).

The control unit 21 counts the number of target objects 10 to which damage occurs by month for each work based on the acquired work type and the acquired occurrence date/time (step S42). The control unit 21 creates the fifth graph based on the counted count results (step S43).

The control unit 21 counts the number of target objects 10 to which damage occurs by month for each vendor based on the acquired vendor and the acquired occurrence date/time (step S44). The control unit 21 creates the sixth graph based on the counted count results (step S45).

The control unit 21 counts the number of target objects 10 to which damage occurs by month for each warehouse based on the acquired warehouse and the acquired occurrence date/time (step S46). The control unit 11 creates the seventh graph based on the counted count results (step S47).

It is noted that the unit period is not limited to the month, and may be day, week, half year, or a specific time period (8:00 to 12:00, and the like).

The control unit 21 allows the display unit 26 to display (output) the created fifth, sixth, and seventh graphs (step S48). The control unit 11 ends the process.

It is noted that, although FIG. 26 illustrates the example in which the fifth, sixth, and seventh graphs are simultaneously displayed on the screen, the present embodiments are not limited to this. For example, the control unit 21 may display at least one of the created fifth, sixth, and seventh graphs on the screen.

It is noted that the server 2 may transmit the created fifth, sixth and seventh graphs to other terminals. It is noted that the process of creating and displaying the fifth, sixth, and seventh graphs may be executed on the RFID reader 1 side.

According to this embodiment, the two-dimensional code corresponding to the code of the RF tag 20 attached to the target object 10, and the information about the target object 10 can be output (transmitted) to the server 2.

According to this embodiment, it is possible to output (transmit) the size data of the target object 10 or the damage information about the damage to the server 2 as the information about the target object 10.

According to this embodiment, it is possible to create the report file based on the information about the target object 10.

According to this embodiment, it is possible to output at least one of the fifth, sixth, and seventh graphs based on the damage information about the target object 10.

### Fifth Embodiment

A fifth embodiment relates to a mode of outputting a position of each target object 10 on a map based on position information of each target object 10. It is noted that the descriptions of the contents overlapping with those of the first to fourth embodiments will be omitted.

FIG. 27 is an explanatory diagram illustrating an example of the record layout of the management DB 251 according to the fifth embodiment. It is noted that the descriptions of the contents overlapping with FIG. 6 will be omitted. The management DB 251 includes the reception column, the inventory count column, and the shipment column. Each of the reception column, the inventory count column, and the shipment column includes the position information column.

The position information column of the reception column stores the position information about the target object 10 at the time of reception of the target object 10. The position information may be, for example, longitude and latitude, location name, warehouse name, or the like. The position information column of the inventory count column stores the position information about the target object 10 at the time of inventory count of the target object 10. The position information column of the shipment column stores the position information about the target object 10 at the time of shipment of the target object 10.

First, the process of storing the position information about the target object 10 attached to the RF tag 20 in association with reading by the RFID reader 1 will be described.

FIG. 28 is a flowchart illustrating a processing procedure for storing the position information about the target object 10. It is noted that the contents overlapping with FIG. 7 are denoted by the same reference numeral, and the description is omitted.

After executing the process of step S103, the control unit 11 of the RFID reader 1 acquires the position information about the target object 10 (step S105). For example, when a global positioning system, global positioning satellite (GPS) module is mounted on the RFID reader 1, the control unit 11 may acquire the position of the target object 10 through the GPS module. It is noted that the position information (for example, location name or warehouse name) may be received manually by the vendor. Alternatively, the vendor may accept the position selection from the plurality of already registered positions.

The control unit 11 transmits the stored UID of the target object 10, the code of the RF tag 20, the reading date/time, the work attribute and the position information to the server 2 through the communication unit 13 (step S106). The control unit 21 of the server 2 receives the UID of the target object 10, the code of the RF tag 20, the reading date/time, the work attribute, and the position information transmitted from the RFID reader 1 through the communication unit 23 (step S203).

The control unit 21 stores the work attribute status, the reading date/time, and the position information in the management DB 251 in association with the received UID of the target object 10 and the code of the RF tag 20 (step S204). The control unit 21 ends the process.

FIG. 29 is an explanatory diagram illustrating an example of a map screen illustrating a position of the target object 10. The screen includes a map display column 14a, a position list 14b, a position marker 14c, and a position display label 14d.

The map display column 14a is a display column displaying the map for displaying the position of each target object 10. The position list 14b is a display column displaying a list of detailed position information of each target object 10. The position marker 14c is a sign or a mark indicating the position of the target object 10 on the map. The position display label 14d is a label displaying information such as an UID and a position of the target object 10.

The server 2 acquires the reading date/time and the position information corresponding to the reading of each target object 10 from the management DB 251 based on the UID of each target object 10. Specifically, the server 2 acquires the reading date/time and the position information corresponding to multiple times (for example, three) readings of each target object 10 from the management DB 251 based on the UID of each target object 10.

It is noted that FIG. 29 illustrates the example of multiple times, but it is not limited to this, and only the reading date/time and the position information corresponding to the most recent reading of the target object 10 may be acquired.

For example, the server 2 acquires, for example, the map from the map-providing server through the communication unit 23. The server 2 displays the acquired map in the map display column 14a. The server 2 displays the marker indicating the position of each target object 10 on the corresponding position marker 14c on the map displayed in the map display column 14a based on the position information corresponding to the most recent reading of each target object 10.

In addition, the server 2 displays the UID of each target object 10 and the reading date/time corresponding to the most recent reading of each target object 10 on the corresponding position display label 14d on the map displayed in the map display column 14a.

The server 2 displays the UID of each target object 10, the reading date/time corresponding to the most recent (current) reading of each target object 10, and the position information corresponding to the reading of each target object 10 multiple times (for example, the most recent, the previous time, and the time before last) in the position list 14b. It is noted that the map screen illustrating the position of the target object 10 may be displayed on the RFID reader 1 side.

FIG. 30 is a flowchart illustrating a processing procedure for outputting the position of the target object 10 on the map. The control unit 21 of the server 2 acquires the position information corresponding to the reading of each target object 10 from the management DB 251 of the large-capacity storage unit 25 based on the UID of each target object 10 (step S261).

For example, the control unit 21 acquires the map from the map-providing server or the like through the communication unit 23 (step S262). The control unit 21 allows the display unit 26 to display (output) the acquired position information of each target object 10 on the acquired map (step S263). For example, the control unit 21 may display the position of each target object 10 on the map with the position marker. The control unit 21 ends the process.

According to this embodiment, the position of each target object 10 can be visualized by outputting the position of each target object 10 on the map.

### Sixth Embodiment

A sixth embodiment relates to a mode of specifying a shelf on which the target object 10 can be stored. It is noted that the description of the contents overlapping with those of the first to fifth embodiments will be omitted.

FIG. 31 is a block diagram illustrating a configuration example of the server 2 according to the sixth embodiment. It is noted that the contents overlapping with FIG. 18 are denoted by the same reference numerals, and the description thereof is omitted. The large-capacity storage unit 25 includes the shelf DB 253. The shelf DB 253 stores the information about the shelf storing the target object 10.

FIG. 32 is an explanatory diagram illustrating an example of the record layout of the shelf DB 253. The shelf DB 253 includes the shelf number column, the space number column, the storage size column, the storage status column, the UID column, and the shelf map column. The shelf number column stores the shelf number for specifying each shelf. The space number column stores the numbers of the spaces provided for distinguishing spaces (areas) within the shelf.

The storage size column stores sizes (vertical dimension, horizontal dimension and height) that are storable in the space. The storage status column stores the storage status of the space (for example, storage-completed or storable). The UID column stores the UID of the target object 10 stored in the space. The shelf map column stores shelf map data.

FIG. 33 is a flowchart illustrating a processing procedure for specifying the storable shelf of the target object 10. The control unit 11 of the RFID reader 1 measures the size of the target object 10 to be stored by using, for example, the LiDAR sensor mounted on the RFID reader 1 (step S171). The control unit 11 acquires the size data of the measured target object 10 (step S172). The control unit 11 transmits the acquired size data to the server 2 through the communication unit 13 (step S173).

The control unit 21 of the server 2 receives the size data transmitted from the RFID reader 1 through the communication unit 23 (step S271). In addition, when the size data of the target object 10 is stored in the target object information DB 252, the control unit 21 may acquire the size data from the target object information DB 252.

The control unit 21 of the server 2 acquires the storage information of the shelf from the shelf DB 253 of the large-capacity storage unit 25 (step S272). The storage information includes shelf position information, storable size data, storage status (storage-completed or storable) of the space in the shelf, UID of the target object 10 storage-completed in the space in the shelf, map of the shelf, and the like. The shelf position information includes the shelf number of each shelf, the space number within each shelf, and the like.

The control unit 21 specifies the shelf number of the shelf in which the target object 10 can be stored and the space number within the shelf based on the acquired storage information of the shelf and the received size data of the target object 10 (step S273).

Specifically, the control unit 21 extracts the shelf number of the shelf including the storable space and the storable space in the shelf from the storage information based on the acquired storage status (storage-completed or storable) of the space in each shelf. The control unit 21 compares the size data of the target object 10 with the storage size of the extracted storable space. When the size of the target object 10 is smaller than the storage size of the storable space, the control unit 21 specifies the space as the storable space in the shelf.

The control unit 21 transmits the specified shelf number and the space number within the shelf to the RFID reader 1 through the communication unit 23 (step S274). The control unit 11 of the RFID reader 1 receives the shelf number of the shelf and the space number within the shelf transmitted from the server 2 through the communication unit 13 (step S174). The control unit 11 displays (outputs) the received shelf number of the shelf and the space number within the shelf on the display unit 15 (step S175). The control unit 11 ends the process.

It is noted that the process for specifying the shelf capable of storing the target object 10 described above may be executed on the RFID reader 1 side.

Sequentially, the display process of the storage status of each shelf based on the storage information of the shelf will be described.

FIG. 34 is an explanatory diagram illustrating an example of a display screen for the shelf storage status. The screen includes a shelf map display column 15a, a first graph display column 15b, and a detail display column 15c.

The shelf map display column 15a is a display column displaying the shelf map including the number of the shelf storing the target object 10 and the storage status of each shelf. The first graph display column 15b is a display column displaying the first graph indicating the ratio of the storage-completed space and the storable space in the storable shelf. The detail display column 15c is a display column displaying detailed information such as the storage-completed space number and the storable space number.

The server 2 acquires the storage information of the shelf including the shelf number of each shelf, the space number in the shelf, the storable size data, the space storage status (storage-completed or storable) in the shelf, the shelf map, and the like from the shelf DB 253. The server 2 displays the acquired shelf map and shelf number in the shelf map display column 15a.

The server 2 determines whether or not each shelf can be storable based on the storage status of the space in each shelf. The server 2 determines that the shelf is stored when there is no storable space in the shelf. The server 2 determines that the shelf is storable when there is a storable space in the shelf.

As illustrated, the stored shelf (shelf numbers: A, B, C, and D) are exemplarily indicated by hatching with diagonal lines falling to the right. In addition, in the storable shelf (shelf number: E), the storage-completed space is exemplarily indicated by hatching with diagonal lines falling to the right, and the storable space is exemplarily indicated without hatching.

In addition, for a storable shelf, the server 2 displays the storage-completed space number and the storable space number in the storable shelf in the detail display column 15c. As illustrated, the storage-completed space numbers are E1 and E2, and the storable space number is E3.

The server 2 creates the first graph based on the storage status of the space within the storable shelf. The server 2 displays the created first graph in the first graph display column 15b.

The first graph is a graph indicating a ratio of the storage-completed space and the storable space within the storable shelf. As illustrated, the first graph is illustrated in the form of the circle graph. The ratio of storage-completed space (full) is 70%, and the ratio of storable space (empty) is 30%. It is noted that the first graph is not limited to the circular graph, and may be various graphs such as the bar graph or the broken line graph.

FIG. 35 is the flowchart illustrating a processing procedure for outputting the shelf map and the first graph. It is noted that the contents overlapping with those in FIG. 33 are denoted by the same reference numerals, and the description thereof is omitted. After executing the process of step S274, the control unit 21 of the server 2 displays the storage information including the number of each shelf, the storage status (storage-completed or storable), the space number in the storable shelf, and the like in the shelf map (step S275).

The control unit 21 creates the first graph indicating the ratio of the storage-completed space and the storable space in the storable shelf (step S276). The control unit 21 allows the display unit 26 to display (output) the created first graph (step S277). The control unit 21 ends the process.

It is noted that the server 2 may transmit the created first graph to other terminals. It is noted that the process of creating and displaying the first graph may be executed on the RFID reader 1 side.

According to this embodiment, it is possible to specify the shelf that can store the target object 10 based on the position information of the shelf and the size data of the target object 10.

According to this embodiment, it is possible to output the map indicating the storage status of the shelf and the first graph.

### Seventh Embodiment

A seventh embodiment relates to a mode of outputting the graph relating to inventory count of the target object 10. It is noted that the description of the contents overlapping with those in the first to sixth embodiments will be omitted. The inventory count is to check the inventory number of the target objects 10.

FIG. 36 is a block diagram illustrating a configuration example of the server 2 according to the seventh embodiment. It is noted that the contents overlapping with those in FIG. 31 are denoted by the same reference numerals, and the description thereof is omitted. The large-capacity storage unit 25 includes the inventory count DB 254 and the inventory management DB 255. The inventory count DB 254 stores the number of target objects 10 for each inventory count of the target object 10. The inventory management DB 255 stores the information such as the inventory number of the target object 10.

FIG. 37 is an explanatory diagram illustrating an example of the record layout of the inventory count DB 254 and the inventory management DB 255.

The inventory count DB 254 includes the year/month column, the inventory count column, and the target number column. The year/month column stores the year/month when the inventory count is performed. The inventory count column stores the number of times (for example, 0, 1, 2, 3, or 4 times) the inventory count of the target object 10 has been performed. The target number column stores the number of target objects 10 corresponding to each number of times of the inventory count.

The number of times of the inventory count and the number of target objects 10 for each number of times of the inventory count are counted from the management DB 251. Specifically, the server 2 acquires the reading date/time of the code of the RF tag 20 attached to each target object 10 at the time of the inventory count where the inventory count status of the target object 10 is “inventory-count-completed” at a predetermined period (for example, January 2023) from the management DB 251. The server 2 counts the number of times of the inventory count for each UID of the target object 10 in a predetermined period based on the acquired reading date/time of the inventory count of the target object 10. The server 2 counts the number of target objects 10 corresponding to the counted number of times of the inventory count from the management DB 251 in a predetermined period.

The inventory management DB 255 includes the year/month column, the inventory number column, and the actual inventory number column. The year/month column stores the target year/month for managing the inventory number of the target object 10. The inventory number column stores the number of target objects 10 that should be in stock for each year and month. The actual inventory number column stores the actual inventory number of the target object 10 for each year and month.

The inventory number is counted from the management DB 251. Specifically, the server 2 acquires the reading date/time of the code of the RF tag 20 attached to each target object 10 at the time of reception for which the inventory count status of the target object 10 “reception-completed” for the last month (January 2022) before the target year and month (for example, February 2022) from the management DB 251. The server 2 counts the number of receptions of the target object 10 in the month before the target year and month as the inventory number for the target year and month based on the reading date/time at the time of reception of the target object 10.

The actual inventory number is obtained from the number of receptions and the number of shipments. Specifically, the server 2 acquires the reading date/time of the code of the RF tag 20 attached to each target object 10 at the time of shipment for which the inventory count status of the target object 10 is “shipment-completed” for the month before the target year and month from the management DB 251. The server 2 counts the number of shipments of the target object 10 for the month before the target year and month based on the acquired reading date/time at the time of shipment of the acquired target object 10. The server 2 calculates the difference between the number of receptions and the number of shipments of the target object 10 counted for the month before the target year and month. The server 2 acquires the calculated difference as the actual inventory number for the target year and month.

It is possible to create the second graph indicating each ratio of the number of times the inventory count of the target object 10 attached with the RF tag 20 is taken in the predetermined period. The predetermined period may be, for example, the last month or the specified month.

FIG. 38 is an explanatory diagram illustrating an example of the display screen of the second graph. The screen includes a second graph display column 16a. The second graph display column 16a is a display column displaying the second graph.

The server 2 acquires the number of target objects 10 corresponding to each number of times of the inventory count from the inventory count DB 254 in the predetermined period (for example, the last month). For example, the number of target objects 10 in four times of inventory count is 3420, the number of target objects 10 in three times of inventory count is 1368, the number of target objects 10 in two times of inventory count is 1368, and the number of target objects 10 in one time of inventory count is 684.

The server 2 creates the second graph indicating each ratio of the number of times of inventory count in the predetermined period based on the inventory count number-of-times information including the predetermined period and the number of target objects 10 corresponding to each number of times of inventory count in the predetermined period.

Specifically, the server 2 calculates each ratio of the number of times of inventory count based on the number of target objects 10 corresponding to each number of times of inventory count. The server 2 creates the second graph indicating each ratio based on each ratio of the calculated number of times of the inventory count. The server 2 displays the created second graph in the second graph display column 16a.

As illustrated, the second graph is illustrated in the form of a circular graph. The ratio of four times of inventory count is 50%, the ratio of three times of inventory count is 20%, the ratio of two times of inventory count is 20%, and the ratio of one time of inventory count is 10%. It is noted that the second graph is not limited to the circle graph, and may be various graphs such as the bar graph or the broken line graph.

FIG. 39 is a flowchart illustrating a processing procedure for outputting the second graph. The control unit 21 of the server 2 acquires the number of target objects 10 corresponding to each number of times of inventory count from the inventory count DB 254 of the large-capacity storage unit 25 in the predetermined period (for example, last month) (step S281). The inventory count number-of-times information includes the predetermined period, the number of target objects 10 corresponding to each number of times of inventory count in the predetermined period, and the like.

The control unit 21 calculates each ratio of the number of times of inventory count based on the number of target objects 10 corresponding to each number of times of inventory count included in the inventory count number-of-times information (step S282). The control unit 21 creates the second graph indicating each ratio based on each ratio of the calculated number of times of the inventory count (step S283). The control unit 21 allows the display unit 26 to display the created second graph (step S284). The control unit 21 ends the process.

It is noted that the server 2 may transmit the created second graph to another terminal. It is noted that the process of creating and displaying the second graph may be executed on the RFID reader 1 side.

In addition, for the predetermined period, a third graph can be created that includes a graph indicating the inventory number of the target object 10 to which the RF tag 20 is attached in chronological order, and a graph indicating the inventory count ratio in chronological order for indicating the error between the number of the target object 10 that should be in stock and the actual inventory number. The predetermined period may be, for example, January to May 2022.

FIG. 40 is an explanatory diagram illustrating an example of the display screen of the third graph. The screen includes a third graph display column 16b. The third graph display column 16b is a display column displaying the third graph. The third graph includes a graph 16b_1 and a graph 16b_2.

The graph 16b_1 is a graph indicating in chronological order the inventory number of the target object 10 attached with the RF tag 20 in the predetermined period. The graph 16b_2 is a graph indicating the inventory count ratio in chronological order for indicating the error between the number of target objects 10 that should be in stock and the actual inventory number.

For each predetermined unit (for example, month) in the predetermined period (for example, January to May 2022), the server 2 acquires the number of target objects 10 that should be in stock and the actual inventory number of the target objects 10 from the management DB 251.

The server 2 creates the graph 16b_1 illustrating the inventory number of the target object 10 in chronological order for each predetermined unit (for example, month) based on the actual inventory number of the target object 10 according to the predetermined period. The server 2 displays the created graph 16b_1 in the third graph display column 16b.

As illustrated, the graph 16b_1 is illustrated in the form of a vertical bar graph. The horizontal axis of the graph 16b_1 indicates a period (for example, January to May 2022). The vertical axis of the graph 16b_1 indicates the inventory number of the target object 10. The graph 16b_1 displays the inventory number of the target object 10 by month from January to May 2022.

For the predetermined period of time, the server 2 calculates the inventory count ratio (error between the number of target objects that should be in inventory and the actual inventory number) of the target object 10 for each predetermined unit (for example, the month) based on the number of target objects 10 that should be in stock and the actual number of target objects 10. The server 2 creates the graph 16b_2 based on the calculated inventory count ratio. The server 2 displays the created graph 16b_2 in the third graph display column 16b.

As illustrated, the graph 16b_2 is illustrated in a broken line form. The graph 16b_2 is a line illustrating transition of the inventory count ratio for indicating the error between the number of target objects 10 that should be in stock and the actual inventory number in January to May, 2022.

It is noted that, although it is illustrated in FIG. 40 that the form of the vertical bar graph and the broken line is used, but the form is not limited to this, and other graph forms may be used.

FIG. 41 is a flowchart illustrating a processing procedure for outputting the third graph. The control unit 21 of the server 2 acquires the number of target objects 10 that should be in stock and the actual inventory number of the target objects 10 from the management DB 251 of the large-capacity storage unit 25 for each predetermined unit (for example, month) according to the predetermined period of time (for example, January to May, 2022) (step S291).

The control unit 21 creates the inventory number graph (graph 16b_1) illustrating the inventory number of the target object 10 in chronological order for each predetermined unit (for example, month) based on the actual inventory number of the target object 10 according to a predetermined period (step S292).

The control unit 21 calculates the inventory count ratio of the target objects 10 for each predetermined unit (for example, month) based on the number of acquired target objects 10 that should be in stock and the actual inventory number of the target objects 10 according to the predetermined period of time (step S293). The control unit 21 creates the inventory count ratio graph (graph 16b_2) based on the calculated inventory count ratio (step S294).

The control unit 21 creates the third graph including the created inventory number graph and the inventory count ratio graph (step S295). The control unit 21 allows the display unit 26 to display (output) the created third graph (step S296). The control unit 21 ends the process.

It is noted that the server 2 may transmit the created third graph to other terminals. It is noted that the process of creating and displaying the third graph may be executed on the RFID reader 1 side.

According to this embodiment, it is possible to output the second graph indicating each ratio of the number of times the inventory count of the target object 10 is taken.

According to this embodiment, it is possible to output the third graph including the graph indicating the inventory number of the target object 10 in chronological order and the graph indicating the inventory count ratio of the target object 10 in chronological order.

### Eighth Embodiment

An eighth embodiment relates to a mode of outputting a graph relating to the inventory retention period of the target object 10. It is noted that the description of the contents overlapping with those of the first to seventh embodiments will be omitted.

For the shipment-completed target object 10, the inventory retention period of the target object can be calculated. The inventory retention period is calculated based on the difference in date/time between the warehousing date/time and the shipment data/time of the target object. Then, a fourth graph indicating the ratio of each inventory retention period can be created.

FIG. 42 is an explanatory diagram illustrating an example of the display screen of the fourth graph. The screen includes a fourth graph display column 17a. The fourth graph display column 17a is a display column displaying the fourth graph. The server 2 acquires the reading date/time (warehousing date/time) of the code of the RF tag 20 attached to each target object 10 at the time of reception, and the reading date/time (shipment date/time) of the code of the RF tag 20 attached to each target object 10 at the time of shipment from the management DB 251.

The server 2 calculates the inventory retention period of the target object 10 based on the difference in date/time between the acquired warehousing date/time and the acquired shipment data/time of the target object 10. For example, the server 2 calculates inventory retention periods including “one month or less”, “one month to three months”, and “three months or more”.

The server 2 creates the fourth graph indicating the calculated ratio of each inventory retention period. Specifically, the server 2 counts the number of target objects 10 corresponding to each inventory retention period. For example, the number of target objects 10 in “one month or less” is 5120, the number of target objects 10 in “one month to three months” is 2080, and the number of target objects 10 in “three months or more” is 640.

The server 2 calculates the ratio of each inventory retention period based on the number of target objects 10 corresponding to each counted inventory retention period. The server 2 creates the fourth graph indicating the calculated ratio of each inventory retention period. The server 2 displays the created fourth graph in the fourth graph display column 17a.

As illustrated, the fourth graph is illustrated in the form of a circle graph. The ratio of “month or less” is 65%, the ratio of “one month to three months” is 27%, and the ratio of “three months or more” is 8%. It is noted that the fourth graph is not limited to the circle graph, and may be various graphs such as a bar graph or a broken line graph.

FIG. 43 is a flowchart illustrating a processing procedure for outputting the fourth graph. The control unit 21 of the server 2 acquires the reading date/time of the code of the RF tag 20 attached to each target object 10 at the time of reception from the management DB 251 of the large-capacity storage unit 25 as the warehousing date/time (step S21). The control unit 21 acquires the reading date/time of the code of the RF tag 20 attached to each target object 10 at the time of shipment from the management DB 251 of the large-capacity storage unit 25 as the shipment date/time (step S22).

The control unit 21 calculates the inventory retention period of the target object 10 based on the difference in date/time between the acquired warehousing date/time and the shipment date/time (step S23). The control unit 21 counts the number of target objects 10 corresponding to each calculated inventory retention period (step S24).

The control unit 21 calculates the ratio of each inventory retention period based on the counted number of target objects 10 corresponding to each inventory retention period (step S25). The control unit 21 creates the fourth graph indicating the calculated ratio of each inventory retention period (step S26). The control unit 21 allows the display unit 26 to display (output) the created fourth graph (step S27). The control unit 21 ends the process.

It is noted that the server 2 may transmit the created fourth graph to other terminals. It is noted that the process of creating and displaying the fourth graph may be executed on the RFID reader 1 side.

According to this embodiment, it is possible to output the fourth graph indicating the ratio of each inventory retention period of the target object 10.

The embodiments disclosed this time are illustrative in all terms and should be considered not restrictive. The scope of the present invention is indicated by the scope of the claims rather than the meaning described above, and is intended to include all modifications within the scope and meaning equivalent to the scope of the claims.

The matters described in each embodiment can be combined with each other. In addition, the independent claims and dependent claims described in the claims can be combined with each other in all possible combinations regardless of the citation form. Furthermore, although the claims use the format in which claims refer to two or more other claims (multi-claim format), it is not limited thereto.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

What is claimed is:

1. An information processing method, comprising:
each time when an RFID reader reads a code of an RF tag, storing a read code of the RF tag and a date/time of reading and a work attribute in association with each other; and
transmitting a stored code of each RF tag, a stored date/time, and a stored work attribute to a server computer,
wherein the server computer stores the code of each RF tag and the date/time and the work attribute in association with each other.

2. The information processing method according to claim 1, further comprising:
storing a reference file storing a plurality of the RF tags to be read in the RFID reader; and
referring to the reference file to determine that the plurality of the RF tags are read excessively or insufficiently when the plurality of the RF tags are read.

3. The information processing method according to claim 2, further comprising:
referring to the reference file and accepting selection of items in the reference file; and
list-displaying the RF tags to be read corresponding to a received item.

4. The information processing method according to claim 2, further comprising:
outputting information indicating that the RF tag is not a read target when reading the RF tag, in a case where the RF tag is an RF tag not stored in the reference file.

5. The information processing method according to claim 1, further comprising:
acquiring a first code of a two-dimensional code attached to the target object;
converting to a second code shorter than an acquired first code; and
setting the second code after conversion as the code of the RF tag.

6. The information processing method according to claim 1, further comprising:
acquiring a first code by reading a two-dimensional code attached to the target object with the RFID reader;
converting to a second code shorter than an acquired first code by using the hash function;
setting a converted second code as the code of the RF tag; and
issuing the RF tag with a set code so as to be attached to the target object.

7. The information processing method according to claim 1, further comprising:
acquiring a code of a first two-dimensional code by reading the first two-dimensional code attached to the target object with the RFID reader;
acquiring a code of a second two-dimensional code by reading the second two-dimensional code corresponding to the code of the RF tag printed on a surface of the RF tag attached to the target object with the RFID reader; and
storing an acquired code of the first two-dimensional code and an acquired code of the second two-dimensional code in association with each other.

8. The information processing method according to claim 1, further comprising:
acquiring a code of the two-dimensional code of a target object attached with the RF tag with the two-dimensional code corresponding to the code of the RF tag printed;
acquiring information about the target object; and
transmitting an acquired information about the target object and an acquired code of the two-dimensional code to the server computer.

9. The information processing method according to claim 8, further comprising:
measuring a size of the target object; and
transmitting data of the size of a measured target object to the server computer as information about the target object.

10. The information processing method according to claim 8, further comprising:
acquiring damage information about damage to the target object; and
transmitting an acquired damage information and an image of the target object to the server computer as the information about the target object.

11. The information processing method according to claim 8, further comprising:
creating a report file containing the information about the target object including size data of the target object, damage information, and an image of the target object and the two-dimensional code of the target object and the code of the two-dimensional code;
outputting a created report file.

12. The information processing method according to claim 1, further comprising:
storing position information about the target object attached with the RF tag in association with the reading of the RFID reader; and
outputting a position of each target object on a map based on the position information of each target object.

13. The information processing method according to claim 1, further comprising:
specifying a storable shelf of the target object to be stored based on the position information of the shelf storage-completed with each target object attached with the RF tag and the size data of the target object to be stored; and
outputting a specified storable shelf.

14. The information processing method according to claim 13, further comprising:
creating a first graph indicating a ratio of the storage-completed space to the storable space in a specified storable shelf based on a storage status of the space in the specified storable shelf; and
outputting a map indicating the storage status of each shelf and a created first graph.

15. The information processing method according to claim 1, further comprising:
creating a second graph indicating each ratio of the number of times a inventory count of the target object attached with the RF tag is taken in a predetermined period;
outputting a created second graph.

16. The information processing method according to claim 1, further comprising:
creating a third graph including a graph indicating the inventory number of the target objects attached with the RF tag in a predetermined period in chronological order and a graph indicating an inventory count ratio for indicating an error between the number of target objects that should be in stock of the target object and the actual inventory number of the target object in chronological order; and
outputting a created third graph.

17. The information processing method according to claim 1, further comprising:
calculating an inventory retention period of a shipment-completed target object attached with the RF tag based on a difference in date/time between a warehousing date/time of the target object and a shipment date/time of the target object;
creating a fourth graph indicating a ratio of each calculated inventory retention period; and
outputting a created fourth graph.

18. The information processing method according to claim 1, further comprising:
acquiring damage information about damage of a target object attached with the RF tag;
creating a fifth graph indicating the number of target objects damaged per unit period for each work including a time of reception and a time of transportation by a lifter based on the damage information;
creating a sixth graph indicating the number of target objects damaged per unit period for each vendor based on the damage information;
creating a seventh graph indicating the number of target objects damaged per unit period for each warehouse storing the target objects based on the damage information; and
outputting at least one of created fifth, sixth, and seventh graphs.

19. A non-transitory computer-readable recording medium with a program recorded to cause a computer to execute processes of:
each time when a code of an RF tag is read, storing a read code of the RF tag and a date/time of reading and a work attribute in association with each other; and
transmitting a stored code of each RF tag, a stored date/time, and a stored work attribute to a server computer.

20. An RFID reader comprising a control unit,
wherein the control unit:
each time when a code of an RF tag is read, stores a read code of the RF tag and a date/time of reading and a work attribute in association with each other;
transmits a stored code of each RF tag, a stored date/time, and a stored work attribute to a server computer.

21. An information processing system comprising:
an RFID reader having a first control unit; and
a server computer storing information read by the RFID reader,
wherein the first control unit
each time when the RFID reader reads a code of an RF tag, stores a read code of the RF tag in association with a date/time when reading is performed and a work attribute, and
transmits a stored code of each RF tag, a stored date/time, and a stored work attribute to the server computer,
wherein the server computer has a second control unit, and
wherein the second control unit:
receives the code of each RF tag, the date/time, and the work attribute transmitted by the first control unit, and
stores the code of each RF tag received in association with the date/time and the work attribute.
